(19) United States
(12) Patent Application Publication
(10) Pub. No.: US 2025/0055656 A1
(43) Pub. Date: Feb. 13, 2025

(54) WIRELESS COMMUNICATION IN SUBBAND FULL DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Jing SUN, San Diego, CA (US)

(21) Appl. No.: 18/447,830

(22) Filed: Aug. 10, 2023

(51) Int. Cl. H04L 5/14; H04L 5/00; H04W 72/1273

(52) U.S. Cl. CPC H04L 5/14; H04L 5/0005; H04L 5/0046; H04W 72/1273

(57) ABSTRACT

Methods, systems, and devices for wireless communications are described. A user equipment (UE) may receive a first configuration that indicates a set of symbols associated with subband full duplex (SBFD) operation. The set of symbols may include a first subset of downlink symbols, a second subset of flexible symbols, a third subset of uplink symbols, or a combination thereof. The second subset of flexible symbols may be associated with an uplink subband. The UE may receive a second configuration associated with monitoring a physical downlink control channel (PDCCH). The UE may receive downlink control information (DCI), based on monitoring the PDCCH, which may include a slot format indicator (SFI) that indicates flexible symbols of the second subset of flexible symbols as uplink or downlink, or a combination thereof. The UE may perform wireless communication based on the first configuration, the second configuration, or the DCI, or a combination thereof.

### FIELD OF TECHNOLOGY

The following relates to wireless communications, including wireless communication in subband full duplex (SBFD) symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The present disclosure relates to improved methods, systems, devices, and apparatuses for managing one or more symbols for wireless communication based at least in part on a slot format indicator (SFI). The SFI may indicate (e.g., allocate, assign, identify) whether a symbol is configured as uplink, downlink, or flexible. For example, a user equipment (UE) may determine one or more symbols for full duplex wireless communication based at least in part on the SFI, and particularly for subband full duplex (SBFD) symbols. An SBFD symbol may be referred to as a symbol that supports both transmission and reception (e.g., uplink communication, downlink communication) simultaneously on subbands. The present disclosure further relates to the behavior of the UE when receiving SFIs for an SBFD symbol associated with uplink and flexible subbands. In some examples, the UE may expect an SFI to update flexible symbols as either downlink or flexible; to update flexible symbols as downlink, flexible, or uplink; or the UE may not expect to receive an SFI. In some other examples, an SFI may indicate that the SBFD symbol is configured as downlink, and the UE may convert the flexible resources to downlink or convert the entire SBFD symbol to downlink. In other examples, the SFI may indicate the SBFD symbol as uplink, and the UE may convert the frequency resources associated with the symbol to uplink. In some other examples, the SFI may indicate the SBFD symbol as flexible, and the UE may update the flexible resources in the symbol to flexible or may update the frequency resources associated with the symbol to flexible.

A method for wireless communications by a UE is described. The method may include receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, receiving second control signaling indicating a second configuration associated with monitoring a physical downlink control channel (PDCCH), receiving downlink control information (DCI) based on monitoring the PDCCH, where the DCI includes an SFI, and where the SFI indicates one or more flexible symbols of the second subset of flexible symbols as uplink or downlink, or a combination thereof, and performing wireless communication based on the first configuration, the second configuration, or the DCI, or a combination thereof.

A UE for wireless communications is described. The UE may include one or more memories storing processor executable code, and one or more processors coupled with the one or more memories. The one or more processors may individually or collectively operable to execute the code to cause the UE to receive first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, receive second control signaling indicating a second configuration associated with monitoring a PDCCH, receive DCI based on monitoring the PDCCH, where the DCI includes an SFI, and where the SFI indicates one or more flexible symbols of the second subset of flexible symbols as uplink or downlink, or a combination thereof, and perform wireless communication based on the first configuration, the second configuration, or the DCI, or a combination thereof.

Another UE for wireless communications is described. The UE may include means for receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, means for receiving second control signaling indicating a second configuration associated with monitoring a PDCCH, means for receiving DCI based on monitoring the PDCCH, where the DCI includes an SFI, and where the SFI indicates one or more flexible symbols of the second subset of flexible symbols as uplink or downlink, or a combination thereof, and means for performing wireless communication based on the first configuration, the second configuration, or the DCI, or a combination thereof.

A non-transitory computer-readable medium storing code for wireless communications is described. The code may include instructions executable by a processor to receive first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, receive second control signaling indicating a second configuration associated with monitoring a PDCCH, receive DCI based on monitoring the PDCCH, where the DCI includes an SFI, and where the SFI indicates one or more flexible symbols of the second subset of flexible symbols as uplink or downlink, or a combination thereof, and perform wireless communication based on the first configuration, the second configuration, or the DCI, or a combination thereof.

Some examples of the method, UEs, and non-transitory computer-readable medium described herein may further include operations, features, means, or instructions for determining that the one or more flexible symbols of the second subset of flexible symbols may be indicated as downlink or flexible based on the SFI and where performing the wireless communication may be based on determining that the one or more flexible symbols of the second subset of flexible symbols may be indicated as downlink or flexible.

Some examples of the method, UEs, and non-transitory computer-readable medium described herein may further include operations, features, means, or instructions for determining whether the DCI includes the SFI and where performing the wireless communication may be based on determining whether the DCI includes the SFI.

Some examples of the method, UEs, and non-transitory computer-readable medium described herein may further include operations, features, means, or instructions for determining that the SFI indicates the one or more flexible symbols of the second subset of flexible symbols as flexible, uplink, downlink, or a combination thereof and where performing the wireless communication may be based on determining that the SFI indicates the one or more flexible symbols of the second subset of flexible symbols as flexible, uplink, downlink, or a combination thereof.

Some examples of the method, UEs, and non-transitory computer-readable medium described herein may further include operations, features, means, or instructions for determining that the SFI includes a slot format value below a threshold value and where the SFI indicates the one or more flexible symbols of the second subset of flexible symbols as uplink or downlink, or a combination thereof, based on the SFI including the slot format value below the threshold value.

Some examples of the method, UEs, and non-transitory computer-readable medium described herein may further include operations, features, means, or instructions for determining that the SFI indicates the one or more flexible symbols of the second subset of flexible symbols as downlink based on the SFI including the slot format value below the threshold value and where performing the wireless communication may be based on determining that the SFI indicates the one or more flexible symbols of the second subset of flexible symbols as downlink.

Some examples of the method, UEs, and non-transitory computer-readable medium described herein may further include operations, features, means, or instructions for determining that the SFI updates one or more frequency resources associated with the one or more flexible symbols of the second subset of flexible symbols to downlink and maintains the uplink subband and one or more guard bands associated with the one or more flexible symbols and where performing the wireless communication may be based on determining that the SFI updates the one or more frequency resources associated with the one or more flexible symbols of the second subset of flexible symbols to downlink and maintains the uplink subband and the one or more guard bands associated with the one or more flexible symbols.

Some examples of the method, UEs, and non-transitory computer-readable medium described herein may further include operations, features, means, or instructions for determining that the SFI updates frequency resources associated with the one or more flexible symbols of the second subset of flexible symbols, including the uplink subband and one or more guard bands, to downlink and where performing the wireless communication may be based on determining that the SFI updates the frequency resources associated with the one or more flexible symbols of the second subset of flexible symbols, including the uplink subband and the one or more guard bands, to downlink.

Some examples of the method, UEs, and non-transitory computer-readable medium described herein may further include operations, features, means, or instructions for determining that the SFI indicates one or more flexible symbols of the second subset of flexible symbols as uplink and where performing the wireless communication may be based on determining that the SFI indicates one or more flexible symbols of the second subset of flexible symbols as uplink.

Some examples of the method, UEs, and non-transitory computer-readable medium described herein may further include operations, features, means, or instructions for determining that the SFI indicates one or more flexible symbols of the second subset of flexible symbols as flexible and where performing the wireless communication may be based on determining that the SFI indicates the one or more flexible symbols of the second subset of flexible symbols as flexible.

Some examples of the method, UEs, and non-transitory computer-readable medium described herein may further include operations, features, means, or instructions for determining that the SFI updates one or more frequency resources associated with the one or more flexible symbols of the second subset of flexible symbols to flexible and maintains the uplink subband and one or more guard bands and where performing the wireless communication may be based on determining that the SFI updates the one or more frequency resources associated with the one or more flexible symbols of the second subset of flexible symbols to flexible and maintains the uplink subband and the one or more guard bands.

Some examples of the method, UEs, and non-transitory computer-readable medium described herein may further include operations, features, means, or instructions for determining that the SFI updates frequency resources associated with the one or more flexible symbols of the second subset of flexible symbols to flexible, including the uplink subband and one or more guard bands and where performing the wireless communication may be based on determining that the SFI updates the frequency resources associated with the one or more flexible symbols of the second subset of flexible symbols to flexible, including the uplink subband and the one or more guard bands.

In some examples of the method, UEs, and non-transitory computer-readable medium described herein, receiving the first control signaling may include operations, features, means, or instructions for receiving a radio resource control (RRC) message indicating the first configuration including the set of symbols associated with the SBFD operation.

In some examples of the method, UEs, and non-transitory computer-readable medium described herein, the DCI includes a DCI format and the DCI format includes a DCI format 2_0.

A method for wireless communications by a network entity is described. The method may include transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, transmitting second control signaling indicating a second configuration associated with monitoring a PDCCH, transmitting DCI, where the DCI includes an SFI, and where the SFI indicates one or more flexible symbols of the second subset of flexible symbols as uplink or downlink, or a combination thereof, and performing wireless communication based on the first configuration, the second configuration, or the DCI, or a combination thereof.

A network entity for wireless communications is described. The network entity may include one or more memories storing processor executable code, and one or more processors coupled with the one or more memories. The one or more processors may individually or collectively operable to execute the code to cause the network entity to transmit first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, transmit second control signaling indicating a second configuration associated with monitoring a PDCCH, transmit DCI, where the DCI includes an SFI, and where the SFI indicates one or more flexible symbols of the second subset of flexible symbols as uplink or downlink, or a combination thereof, and perform wireless communication based on the first configuration, the second configuration, or the DCI, or a combination thereof.

Another network entity for wireless communications is described. The network entity may include means for transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, means for transmitting second control signaling indicating a second configuration associated with monitoring a PDCCH, means for transmitting DCI, where the DCI includes an SFI, and where the SFI indicates one or more flexible symbols of the second subset of flexible symbols as uplink or downlink, or a combination thereof, and means for performing wireless communication based on the first configuration, the second configuration, or the DCI, or a combination thereof.

A non-transitory computer-readable medium storing code for wireless communications is described. The code may include instructions executable by a processor to transmit first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband, transmit second control signaling indicating a second configuration associated with monitoring a PDCCH, transmit DCI, where the DCI includes an SFI, and where the SFI indicates one or more flexible symbols of the second subset of flexible symbols as uplink or downlink, or a combination thereof, and perform wireless communication based on the first configuration, the second configuration, or the DCI, or a combination thereof.

In some examples of the method, network entities, and non-transitory computer-readable medium described herein, the one or more flexible symbols of the second subset of flexible symbols may be indicated as downlink or flexible based on the SFI.

In some examples of the method, network entities, and non-transitory computer-readable medium described herein, the DCI includes the SFI.

In some examples of the method, network entities, and non-transitory computer-readable medium described herein, the SFI indicates the one or more flexible symbols of the second subset of flexible symbols as flexible, uplink, downlink, or a combination thereof.

In some examples of the method, network entities, and non-transitory computer-readable medium described herein, the SFI includes a slot format value below a threshold value.

In some examples of the method, network entities, and non-transitory computer-readable medium described herein, the SFI indicates the one or more flexible symbols of the second subset of flexible symbols as downlink based on the SFI including the slot format value below the threshold value.

In some examples of the method, network entities, and non-transitory computer-readable medium described herein, the SFI updates one or more frequency resources associated with the one or more flexible symbols of the second subset of flexible symbols to downlink and maintains the uplink subband and one or more guard bands associated with the one or more flexible symbols.

In some examples of the method, network entities, and non-transitory computer-readable medium described herein, the SFI updates frequency resources associated with the one or more flexible symbols of the second subset of flexible symbols, including the uplink subband and one or more guard bands, to downlink.

In some examples of the method, network entities, and non-transitory computer-readable medium described herein, the SFI indicates one or more flexible symbols of the second subset of flexible symbols as uplink.

In some examples of the method, network entities, and non-transitory computer-readable medium described herein, the SFI indicates one or more flexible symbols of the second subset of flexible symbols as flexible.

In some examples of the method, network entities, and non-transitory computer-readable medium described herein, the SFI updates one or more frequency resources associated with the one or more flexible symbols of the second subset of flexible symbols to flexible and maintains the uplink subband and one or more guard bands.

In some examples of the method, network entities, and non-transitory computer-readable medium described herein, the SFI updates frequency resources associated with the one or more flexible symbols of the second subset of flexible symbols to flexible, including the uplink subband and one or more guard bands.

In some examples of the method, network entities, and non-transitory computer-readable medium described herein, transmitting the first control signaling may include operations, features, means, or instructions for transmitting an RRC message indicating the first configuration including the set of symbols associated with the SBFD operation.

### BRIEF DESCRIPTION OF THE DRAWINGS

FIGS. 1 and 2 show examples of wireless communications systems that support wireless communication (SBFD) symbols in accordance with one or more aspects of the present disclosure.

FIG. 3 through 6 show examples of resource diagrams that support wireless communication in SBFD symbols in accordance with one or more aspects of the present disclosure.

FIG. 7 shows an example of a process flow diagram that supports wireless communication in SBFD symbols in accordance with one or more aspects of the present disclosure.

FIGS. 8 and 9 show block diagrams of devices that support wireless communication in SBFD symbols in accordance with one or more aspects of the present disclosure.

FIG. 10 shows a block diagram of a communications manager that supports wireless communication in SBFD symbols in accordance with one or more aspects of the present disclosure.

FIG. 11 shows a diagram of a system including a device that supports wireless communication in SBFD symbols in accordance with one or more aspects of the present disclosure.

FIGS. 12 and 13 show block diagrams of devices that support wireless communication in SBFD symbols in accordance with one or more aspects of the present disclosure.

FIG. 14 shows a block diagram of a communications manager that supports wireless communication in SBFD symbols in accordance with one or more aspects of the present disclosure.

FIG. 15 shows a diagram of a system including a device that supports wireless communication in SBFD symbols in accordance with one or more aspects of the present disclosure.

FIGS. 16 through 18 show flowcharts illustrating methods that support wireless communication in SBFD symbols in accordance with one or more aspects of the present disclosure.

### DETAILED DESCRIPTION

A UE may be configured to support full duplex operations. For example, the UE may be configured to support full duplex wireless communications, in which the UE may receive wireless communication (e.g., downlink communication) and transmit wireless communication (e.g., uplink communication) simultaneously. The UE may also support the full duplex wireless communications over a subband (also referred to as a radio frequency spectrum subband) that spans a portion of a band (also referred to as a radio frequency spectrum band). The UE may be configured to support the full duplex wireless communications over a subband in one or more time and frequency resources (e.g., symbols, slots, subcarriers). For example, the UE may be configured with a configuration that allocates and defines one or more symbols within a slot for downlink, uplink, or flexible. The UE may perform uplink communication, downlink communication, or a combination thereof, on one or more symbols configured as downlink, uplink, or flexible.

The UE may receive a configuration that includes a set of symbols, including one or more downlink symbols, one or more flexible symbols, one or more uplink symbols, one or more subband full duplex (SBFD) symbols, or any combination thereof. An SBFD symbol may be referred to as a symbol that supports both transmission and reception (e.g., uplink communication, downlink communication) simultaneously on separate subbands. The subbands within an SBFD symbol may be downlink subbands, flexible subbands, uplink subbands, guard bands, or any combination thereof. The UE may also support slot format indicators (SFIs), which may be received via downlink control information (DCI) to assign resources within a flexible symbol as downlink resources, uplink resources, or flexible resources. However, for a UE supporting SBFD symbols, there may be uncertainty regarding SFI assignments for the different subbands within an SBFD symbol. For example, the UE may receive a configuration including an SBFD symbol that includes one or more uplink subbands, one or more guard bands, and one or more flexible subbands. After receiving SFI assigning the symbol for downlink, the UE may be unclear whether to convert the resources in the subband (e.g., including one or more uplink subbands) to downlink or to convert exclusively the flexible subbands within the SBFD symbol to downlink.

The present disclosure relates to improved methods, systems, devices, and apparatuses that enable a UE to manage one or more symbols for wireless communication based at least in part on an SFI received via DCI (e.g., a DCI format 2_0). The SFI may indicate (e.g., allocate, assign, identify) whether a symbol is configured as uplink, downlink, or flexible. Specifically, the UE may determine one or more symbols for full duplex wireless communication based at least in part on the SFI, and particularly for SBFD symbols. The present disclosure further relates to the behavior of the UE when receiving SFIs for an SBFD symbol associated with uplink and flexible subbands. In some examples, the UE may expect an SFI to update flexible symbols as either downlink or flexible; the UE may expect an SFI to update flexible symbols as downlink, flexible, or uplink; or the UE may not expect to receive an SFI. In some other examples, an SFI may indicate that the SBFD symbol is configured as downlink, and the UE may convert the flexible resources (e.g., excluding one or more uplink subbands) to downlink or convert the entire SBFD symbol to downlink. In other examples, the SFI may indicate the SBFD symbol as uplink, and the UE may convert the frequency resources associated with the symbol to uplink (e.g., including one or more uplink subbands). In some other examples, the SFI may indicate the SBFD symbol as flexible, and the UE may update the flexible resources in the symbol to flexible or may update the frequency resources associated with the symbol to flexible (e.g., the UE may update an uplink subband associated with the symbol to flexible).

Aspects of the disclosure are initially described in the context of wireless communications systems. Aspects of the disclosure are then described in the context of resource diagrams and a process flow. Aspects of the disclosure are further illustrated by and described with reference to apparatus diagrams, system diagrams, and flowcharts that relate to wireless communication in SBFD symbols.

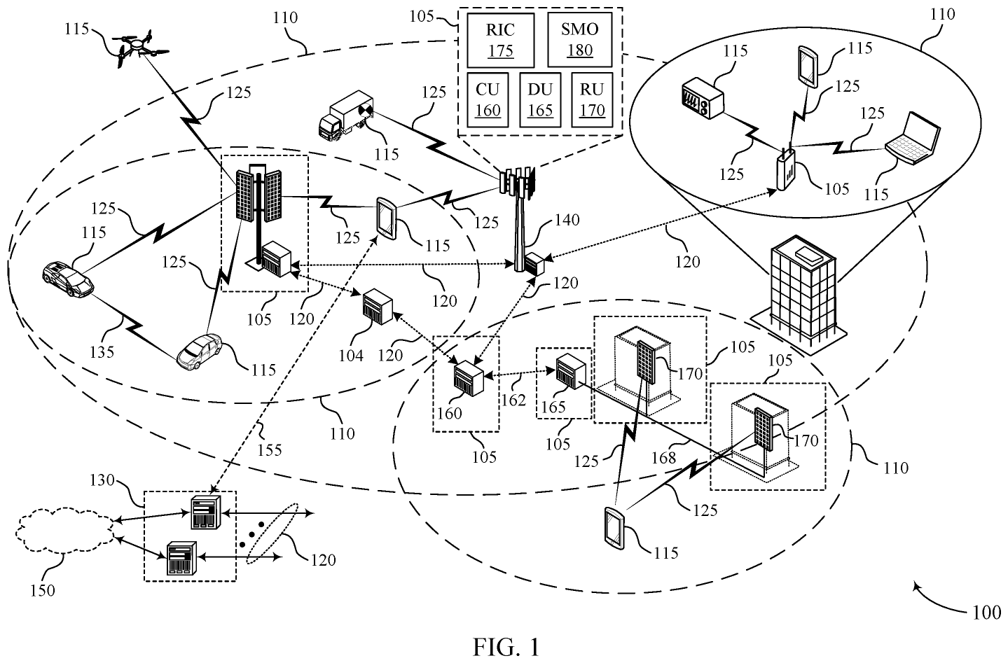

FIG. 1 shows an example of a wireless communications system 100 that supports wireless communication in SBFD symbols in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support wireless communication in SBFD symbols as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

For SBFD operation in a symbol configured as flexible in TDD-UL-DL-ConfigCommon, an SBFD-aware UE may have at least two options. In one option, uplink transmissions may be allowed within an uplink subband in the SBFD symbol and not allowed outside of an uplink subband in the symbol SBFD. Downlink receptions may be allowed within downlink subbands of the SBFD symbol, and may be allowed outside downlink subbands of the SBFD symbol. In a second option, uplink transmissions may be allowed within an uplink subband of the SBFD symbol, while resource blocks outside of an uplink subband may be used as either uplink or downlink (excluding any guard bands). The transmission direction (e.g., uplink or downlink) for the resource blocks within the SBFD symbol may be the same. For example, if the SBFD symbol is indicated as uplink, the flexible subbands within the SBFD symbol may be converted to uplink. Downlink receptions may be allowed within a downlink subband of the SBFD symbol and the SBFD symbol may be allowed to convert to a downlink-only symbol. For both options, uplink transmissions may be within active uplink bandwidth parts (BWPs) and downlink receptions may be within active downlink BWPs in the SBFD symbol. For the resource blocks outside the uplink subband, the UE may not use separate resource blocks for downlink and uplink simultaneously.

In some examples, an SBFD-aware UE may receive DCI (e.g., a DCI format 2_0) including an SFI to update one or more flexible slots or symbols to downlink, uplink, or flexible. In some examples, the SFI may point to an entry in a table (e.g., slotFormatCombinationld=3) that includes a particular configuration of uplink, downlink, and flexible resources. The UE may manage resources accordingly.

A semi-flexible symbol may refer to a symbol indicated as flexible by tdd-UL-DL-ConfigurationCommon, or tdd-ULDL-ConfigurationDedicated. In some examples, the SBFD-aware UE that supports receiving SFI via DCI format 2_0 may experience ambiguity about UE behavior in response to SFI that updates a subset of flexible symbols. For example, the SBFD-aware UE may be uncertain how to respond to an SFI indicating a semi-flexible symbol on which an uplink subband is configured as a downlink symbol, an uplink symbol, or as an SFI flexible symbol.

The wireless communications system 100 may support management of one or more symbols for wireless communication based at least in part on an SFI received from a network entity 105. The SFI may indicate (e.g., allocate, assign, identify) whether a symbol is configured as uplink, downlink, or flexible. For example, a UE 115 may determine one or more symbols for full duplex wireless communication based at least in part on the SFI, and particularly for SBFD symbols. The present disclosure further relates to the behavior of the UE 115 when receiving SFIs for an SBFD symbol associated with uplink and flexible subbands. In some examples, the UE 115 may expect an SFI to update flexible symbols as either downlink or flexible; to update flexible symbols as downlink, flexible, or uplink; or the UE 115 may not expect to receive an SFI from the network entity 105. In some other examples, an SFI may indicate that the SBFD symbol is configured as downlink, and the UE 115 may convert the flexible resources to downlink or convert the entire SBFD symbol to downlink. In other examples, the SFI may indicate the SBFD symbol as uplink, and the UE 115 may convert the frequency resources associated with the symbol to uplink. In some other examples, the SFI may indicate the SBFD symbol as flexible, and the UE 115 may update the flexible resources in the symbol (e.g., excluding one or more uplink subbands) to flexible or may update the frequency resources associated with the symbol (e.g., including one or more uplink subbands) to flexible.

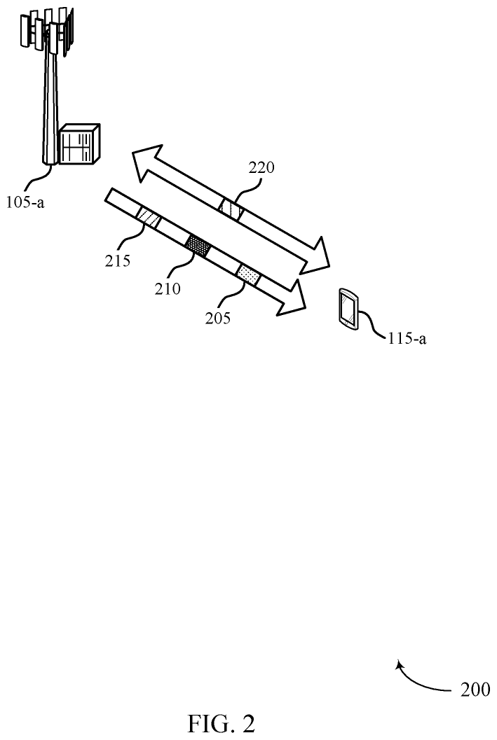

FIG. 2 shows an example of a wireless communications system 200 that supports wireless communication in SBFD symbols in accordance with one or more aspects of the present disclosure. The wireless communications system 200 may implement or be implemented by one or more aspects of the wireless communications system 100. For example, the wireless communications system 200 may include a network entity 105-a and a UE 115-a, which may represent examples of a network entity 105 and a UE 115 described with reference to FIG. 1.

In the wireless communications system 200, the network entity 105-a may support full duplex operation, in which the network entity 105-a may perform simultaneous transmission of downlink communication to the UE 115-a and reception of uplink communication from the UE 115-a. Additionally, or alternatively, the UE 115-a may support full duplex operation, in which the UE 115-a may perform simultaneous transmission of uplink communication to the network entity 105-a and reception of downlink communication from the network entity 105-a.

In the example of FIG. 2, the network entity 105-a and the UE 115-a may support full duplex operation on one or more SBFD symbols. For example, the network entity 105-a may transmit, to the UE 115-a, first control signaling 205. First control signaling 205 may indicate a first configuration that includes a set of symbols associated with SBFD operation (e.g., SBFD symbols). The set of SBFD symbols may include a first subset of downlink symbols, a second subset of flexible symbols, a third subset of uplink symbols, or a combination thereof. In some examples, the second subset of flexible symbols may be associated with an uplink subband. That is, a subset of frequency resources within one or more flexible SBFD symbols may be configured for uplink transmissions, based on the first configuration indicated in first control signaling 205.

The network entity 105-a may transmit, to the UE 115-a, second control signaling 210 that indicates a second configuration. The second configuration may be associated with monitoring a physical downlink control channel (PDCCH). That is, the UE 115-a may be configured to monitor a PDCCH (e.g., for DCI) based on the second configuration indicated in second control signaling 210. The network entity 105-a may transmit, to the UE 115-a, DCI 215 (e.g., a DCI format 2_0) including an SFI. The SFI may indicate one or more flexible symbols of the second subset of flexible symbols as uplink, or downlink, or a combination thereof.

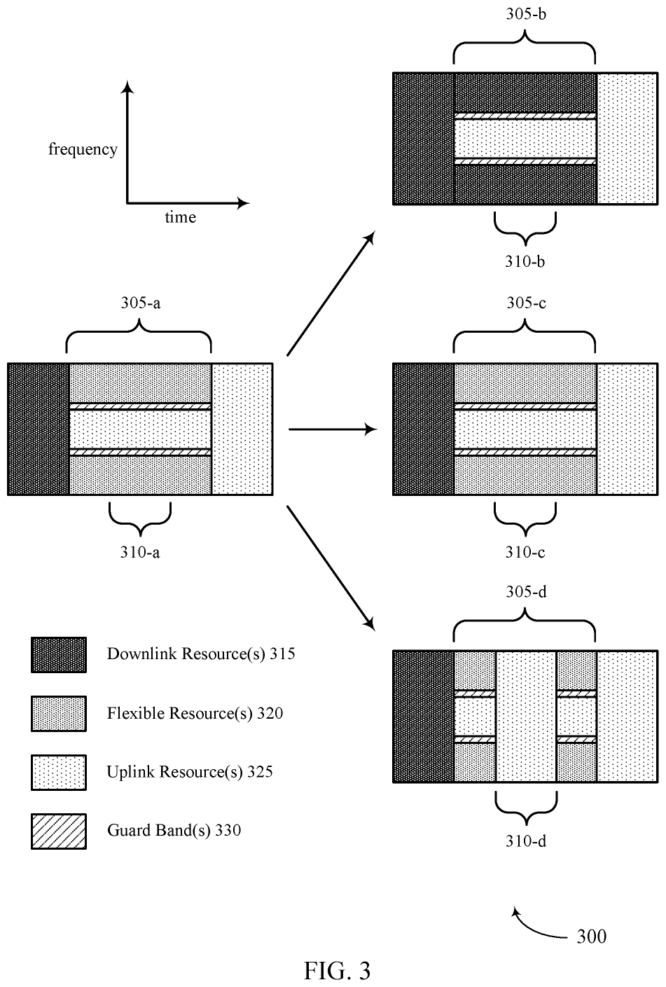

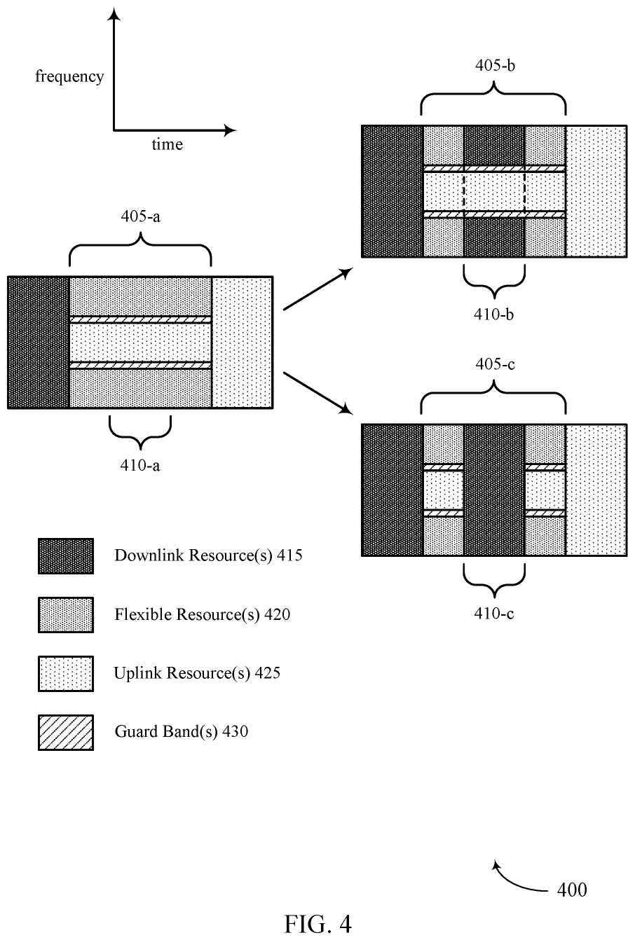

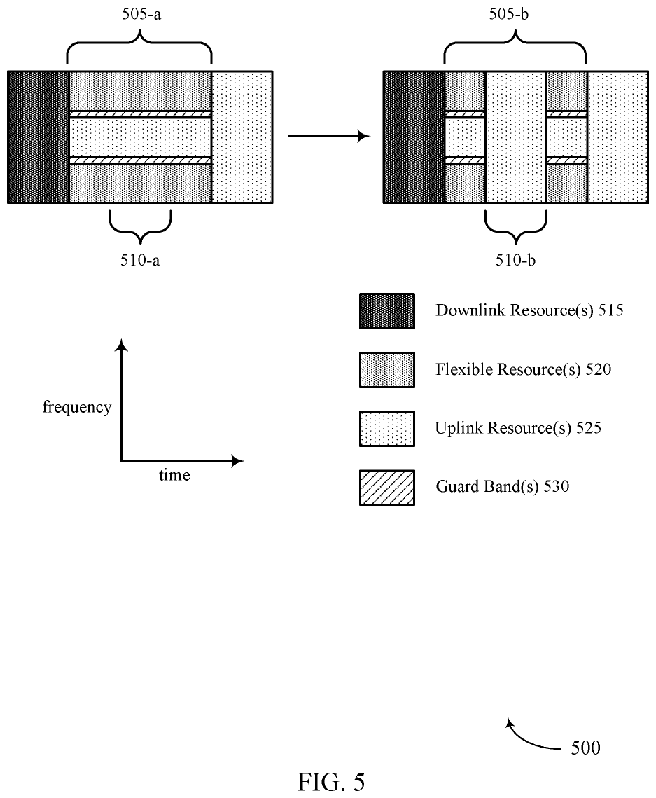

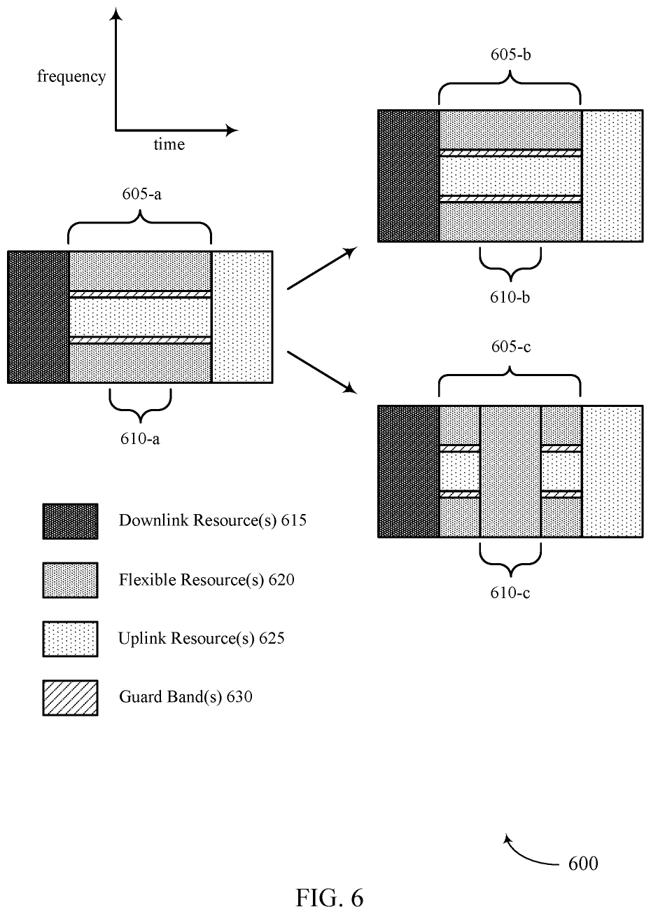

For example, the UE 115-a may expect the SFI to update flexible symbols as either downlink or flexible; to update flexible symbols as downlink, flexible, or uplink; or the UE 115 may not expect to receive an SFI from the network entity 105-a, as described in more detail with reference to FIG. 3. In some other examples, the SFI may indicate that the SBFD symbol is configured as downlink, and the UE 115-a may convert the flexible resources to downlink or convert the entire SBFD symbol to downlink, as described in more detail with reference to FIG. 4. In other examples, the SFI may indicate the SBFD symbol as uplink, and the UE 115-a may convert the frequency resources associated with the symbol to uplink, as described in more detail with reference to FIG. 5. In some other examples, the SFI may indicate the SBFD symbol as flexible, and the UE 115-a may update the flexible resources in the symbol to flexible or may update the frequency resources associated with the symbol (e.g., including one or more uplink subbands) to flexible, as described in more detail with reference to FIG. 6.

The network entity 105-a and the UE 115-a may perform wireless communications 220 based on the first control signaling 205, the second control signaling 210, the DCI 215, or a combination thereof.

FIG. 3 shows an example of a resource diagram 300 that supports wireless communication in SBFD symbols in accordance with one or more aspects of the present disclosure. The resource diagram 300 may implement or be implemented by one or more aspects of the wireless communications system 100 and the wireless communications system 200 described with reference to FIGS. 1 and 2, respectively. For example, the resource diagram 300 may be implemented by a network entity 105 and a UE 115 described with reference to FIGS. 1 and 2, respectively, to support full duplex wireless communication.

A UE 115 may receive first control signaling indicating a first configuration including a set of SBFD symbols, such as an SBFD symbol set 305-a. In some examples, the SBFD symbol set 305-a may include one or more downlink resources 315 (e.g., downlink symbol(s) or downlink subband(s)), one or more flexible resources 320 (e.g., flexible symbol(s) 310-a or flexible subband(s)), and one or more uplink resources 325 (e.g., uplink symbol(s) or uplink subband(s)). The flexible symbol(s) 310-a may include one or more uplink resources 325 (e.g., uplink subband) associated with one or more guard bands 330 and one or more flexible resources (e.g., flexible subbands). The UE 115 may receive second control signaling indicating a second configuration associated with monitoring a PDCCH. The UE 115 may receive a DCI (e.g., a DCI format 2_0) based on monitoring the PDCCH, where the DCI includes an SFI. The SFI may indicate the flexible symbol(s) 310-a of SBFD symbol set 305-a as either uplink or downlink, or a combination thereof. In the example of FIG. 3, the resource diagram 300 depicts three exemplary UE responses to receiving the SFI.

In some examples, the UE 115 may receive an SFI indicating the flexible symbol(s) 310-a of SBFD symbol set 305-a as either downlink or flexible. That is, the UE 115 may not expect to receive an SFI indicating the flexible symbol(s) 310-a as an uplink symbol. The SBFD symbol set 305-b depicts the SBFD symbols after the UE 115 receives SFI indicating the flexible symbol(s) 310-b as downlink, and contains an uplink subband and guard bands unchanged from SBFD symbol set 305-a, and two downlink subbands instead of flexible subbands. The UE 115 may perform wireless communications with the network entity 105 based on the SBFD symbol set 305-b. As described in more detail with reference to FIG. 4, the UE 115 may determine (e.g., read, decode, interpret) the SFI to indicate the entire flexible symbol(s) 310-b as downlink, or to indicate exclusively the flexible resources 320 within the flexible symbol(s) 310-b as downlink.

In some examples, the UE 115 may not receive a DCI including an SFI for SBFD symbol(s) and slot(s). In such examples, the UE 115 may not expect to receive the SFI in the SBFD symbol(s) or SBFD slot(s). The UE 115 may, as a result, refrain from updating the SBFD symbol set 305-c, leaving the flexible resources 320 associated with the flexible symbol(s) 310-c as flexible. The UE 115 may perform wireless communications with the network entity 105 based on the SBFD symbol set 305-c.

In some examples, the UE 115 may receive SFI indicating the flexible symbol(s) 310-a of SBFD symbol set 305-a as either downlink, flexible, uplink, or any combination thereof. The SBFD symbol set 305-d depicts the SBFD symbols after the UE 115 receives SFI indicating the flexible symbol(s) 310-b as uplink, and where the flexible symbol(s) 310-d includes no guard bands 330, downlink resources 315, or flexible resources 320. The UE 115 may perform wireless communications with the network entity 105 based on the SBFD symbol set 305-d.

FIG. 4 shows an example of a resource diagram 400 that supports wireless communication in SBFD symbols in accordance with one or more aspects of the present disclosure. The resource diagram 400 may implement or be implemented by one or more aspects of the wireless communications system 100 and the wireless communications system 200 described with reference to FIGS. 1 and 2, respectively. For example, the resource diagram 400 may be implemented by a network entity 105 and a UE 115 described with reference to FIGS. 1 and 2, respectively, to support full duplex wireless communication. The resource diagram 400 shows SBFD symbol sets 405-a, 405-b, and 405-c, which may be examples of the SBFD symbol sets 305-a and 305-b described with reference to FIG. 3.

A UE 115 may receive first control signaling indicating a first configuration including a set of SBFD symbols, such as the SBFD symbol set 405-a. In one example, the initial SBFD symbol set 405-a may include one or more downlink resources 415 (e.g., downlink symbol(s) or downlink subband(s)), one or more flexible resources 420 (e.g., flexible symbol(s) 410-a or flexible subband(s)), and one or more uplink resources 425 (e.g., uplink symbol(s) or uplink subband(s)). The flexible symbol(s) 410-a may include one or more uplink resources 425 (e.g., an uplink subband) surrounded by one or more guard bands 430 and one or more flexible resources 420 (e.g., flexible subbands). The UE 115 may receive second control signaling indicating a second configuration associated with monitoring a PDCCH. The UE 115 may receive DCI based on monitoring the PDCCH, where the DCI includes an SFI. For example, the DCI may include a DCI format 2_0 with a slot format value other than a specific value (e.g., 255). The SFI may indicate the flexible symbol(s) 410-a associated with the SBFD symbol set 405-a as either uplink or downlink, or a combination thereof. The resource diagram 400 depicts two exemplary UE responses (e.g., interpretations) to receiving an SFI indicating the flexible symbol(s) 410-a as downlink.

In some examples, the UE 115 may interpret (e.g., read, decode) an SFI as indicating the flexible symbol(s) 410-a of the SBFD symbol set 405-a as downlink to apply exclusively to the flexible resources 420 (e.g., the flexible subbands) within the flexible symbol(s) 410-a. For example, the SBFD symbol set 405-b depicts the SBFD symbols after the UE 115 receives SFI indicating the flexible symbol(s) 410-b as downlink with that interpretation. Note that the SBFD symbol set 405-b includes the uplink resources 425 and guard bands 430 unchanged from the SBFD symbol set 405-a, and downlink resources 415 in the place of flexible resources 420. The UE 115 may perform wireless communications with the network entity 105 based on the SBFD symbol set 405-b.

In some examples, the UE 115 may interpret (e.g., read, decode) an SFI as indicating the flexible symbol(s) 410-a of the SBFD symbol set 405-a as downlink and to apply to the frequency resources within the flexible symbol(s) 410-a, including the uplink subband and the guard bands 430. That is, the SFI may override the uplink resources 425 within the flexible symbol(s) 410-a. For example, the SBFD symbol set 405-c depicts the SBFD symbols after the UE 115 receives SFI indicating the flexible symbol 410-c as downlink with that interpretation. This signaling switches SBFD symbols to non-SBFD symbols (e.g., downlink symbols in this example). Note that the SBFD symbol set 405-c includes exclusively downlink resources 415 and no uplink resources 425 or guard bands 430 from the SBFD symbol set 405-a. The UE 115 may perform wireless communications with the network entity 105 based on the SBFD symbol set 405-c.

FIG. 5 shows an example of a resource diagram 500 that supports wireless communication in SBFD symbols in accordance with one or more aspects of the present disclosure. The resource diagram 500 may implement or be implemented by one or more aspects of the wireless communications system 100 and the wireless communications system 200 described with reference to FIGS. 1 and 2, respectively. For example, the resource diagram 500 may be implemented by a network entity 105 and a UE 115 described with reference to FIGS. 1 and 2, respectively, to support full duplex wireless communication. The resource diagram 500 shows SBFD symbol sets 505-a and 505-b, which may be examples of the SBFD symbol sets 305-a and 305-d, respectively, as described with reference to FIG. 3.

The UE 115 may receive first control signaling indicating a first configuration including a set of SBFD symbols, such as the SBFD symbol set 505-a. In one example, the SBFD symbol set 505-a may include one or more downlink resources 515 (e.g., downlink symbol(s) or downlink subband(s)), one or more flexible resources 520 (e.g., flexible symbol(s) 510-a or flexible subband(s)), and one or more uplink resources 525 (e.g., uplink symbol(s) or uplink subband(s)). The flexible symbol(s) 510-a may include one or more uplink resources 525 (e.g., an uplink subband) surrounded by one or more guard bands 530 and one or more flexible resources 420 (e.g., flexible subbands). The UE 115 may receive second control signaling indicating a second configuration associated with monitoring a PDCCH. The UE 115 may receive DCI based on monitoring the PDCCH, where the DCI includes an SFI. For example, the DCI may include a DCI format 2_0 with a slot format value other than specific value(s) (e.g., 255). The SFI may indicate the flexible symbol(s) 510-a of SBFD symbol set 505-a as either uplink or downlink, or a combination thereof. The resource diagram 500 depicts an exemplary UE response (e.g., interpretation) to receiving an SFI indicating the flexible symbol(s) 510-a as uplink.

In some examples, the UE 115 may interpret an SFI indicating the flexible symbol(s) 510-a of SBFD symbol set 505-a as uplink to apply to the frequency resources within the flexible symbol(s) 510-a, including the guard bands 530. For example, the SBFD symbol set 505-b depicts the SBFD symbols after the UE 115 receives SFI indicating the flexible symbol(s) 510-b as uplink with that interpretation. Note that the SBFD symbol set 505-b includes exclusively uplink resources 525 and no guard bands 530 from the SBFD symbol set 505-a. The UE 115 may cancel any RRC-configured downlink transmissions in the flexible symbol(s) 510-b. The UE 115 may perform wireless communications with the network entity 105 based on the SBFD symbol set 505-b.

FIG. 6 shows an example of a resource diagram 600 that supports wireless communication in SBFD symbols in accordance with one or more aspects of the present disclosure. The resource diagram 600 may implement or be implemented by one or more aspects of the wireless communications system 100 and the wireless communications system 200 described with reference to FIGS. 1 and 2, respectively. For example, the resource diagram 600 may be implemented by a network entity 105 and a UE 115 described with reference to FIGS. 1 and 2, respectively, to support full duplex wireless communication. The resource diagram 600 shows SBFD symbol set 605-a, which may be an example of the SBFD symbol set 305-a described with reference to FIG. 3.

A UE 115 may receive first control signaling indicating a first configuration including a set of SBFD symbols, such as the SBFD symbol set 605-a. In one example, the initial SBFD symbol set 605-a may include one or more downlink resources 615 (e.g., downlink symbol(s) or downlink subband(s)), one or more flexible resources 620 (e.g., flexible symbol(s) 610-a or flexible subband(s)), and one or more uplink resource 625 (e.g., uplink symbol(s) or uplink subband(s)). The flexible symbol(s) 610-a may include one or more uplink resources 625 (e.g., an uplink subband) surrounded by one or more guard bands 630 and one or more flexible resources 620 (e.g., flexible subbands). The UE 115 may receive second control signaling indicating a second configuration associated with monitoring a PDCCH. The UE 115 may receive DCI based on monitoring the PDCCH, where the DCI includes an SFI. For example, the DCI may include a DCI format 2_0 with a slot format value other than a specific value (e.g., 255). The SFI may indicate the flexible symbol(s) 610-a of SBFD symbol set 605-a as either uplink or downlink, or a combination thereof. The resource diagram 600 depicts two exemplary UE responses (e.g., interpretations) to receiving an SFI indicating the flexible symbol(s) 610-a as flexible. In such examples, the UE 115 drops or cancels higher-layer configured transmissions and receptions (e.g., CSI-RS, sounding reference signals (SRSs), physical uplink control channel (PUCCH), physical uplink shared channel (PUSCH), or any combination thereof).

In some examples, the UE 115 may interpret an SFI indicating the flexible symbol(s) 610-a of SBFD symbol set 605-a as flexible to apply exclusively to the flexible resources 620 (e.g., the flexible subbands) within the flexible symbol(s) 610-a. For example, the SBFD symbol set 605-b depicts the SBFD symbols after the UE 115 receives SFI indicating the flexible symbol(s) 610-b as flexible with that interpretation. Note that the SBFD symbol set 605-b includes the uplink resources 625 and guard bands 630 unchanged from the SBFD symbol set 605-a, and flexible resources 620. The UE 115 may perform wireless communications with the network entity 105 based on the SBFD symbol set 605-b.

In some examples, the UE 115 may interpret an SFI indicating the flexible symbol(s) 610-a of SBFD symbol set 605-a as flexible to apply to the frequency resources within the flexible symbol(s) 610-a, including the uplink subband and the guard bands 630. That is, the SFI may override the uplink resources 625 within the flexible symbol(s) 610-a. For example, the SBFD symbol set 605-c depicts the SBFD symbols after the UE 115 receives SFI indicating the flexible symbol(s) 610-c as flexible with that interpretation. Note that the SBFD symbol set 605-c includes exclusively flexible resources 620 and no uplink resources 625 or guard bands 630 from the SBFD symbol set 605-a. That is, the flexible symbol(s) 610-a becomes SFI-flexible symbol 610-c. The UE 115 may perform wireless communications with the network entity 105 based on the SBFD symbol set 605-c.

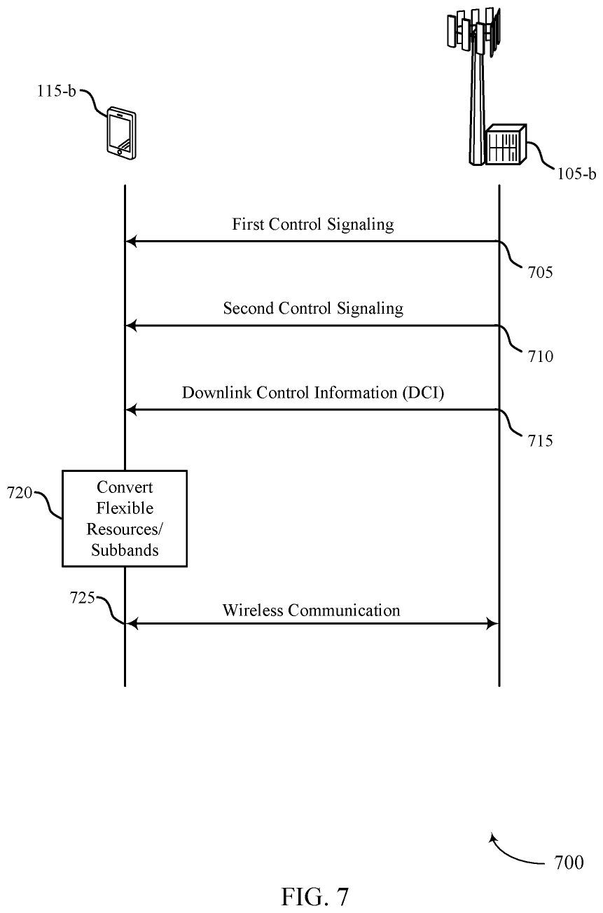

FIG. 7 shows an example of a process flow 700 that supports wireless communication in SBFD symbols in accordance with one or more aspects of the present disclosure. In some examples, the process flow 700 may implement or be implemented by aspects of the wireless communications system 100, the wireless communications system 200, the resource diagram 300, the resource diagram 400, the resource diagram 500, the resource diagram 600, or any combination thereof. For example, the process flow 700 may include a UE 115-b and a network entity 105-b, which may be examples of corresponding devices described herein with respect to FIG. 1. Following the process flow 700, the network entity 105-b may configure the UE 115-b to perform wireless communications via SBFD flexible symbols indicated as downlink, flexible, uplink, or any combination thereof. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 700, some aspects of some operations may also be performed by one or more other wireless devices.

At 705, the network entity 105-b may transmit, to the UE 115-b, first control signaling that indicates a first configuration. The first configuration may include a set of symbols associated with SBFD operation (e.g., SBFD symbols). The set of SBFD symbols may include one or more of a first subset of downlink symbols, a second subset of flexible symbols, a third subset of uplink symbols, or a combination thereof. The second subset of flexible symbols may be associated with an uplink subband. That is, the second subset of flexible symbols may include at least one flexible symbol that includes at least one uplink subband. A flexible symbol that includes at least one uplink subband may also include one or more flexible subbands and one or more guard bands separating the frequency resources of the at least one uplink subband from the frequency resources of the one or more flexible subbands. In some examples, the first control signaling may be an RRC message, such that the first configuration is included in the RRC message. In some examples, the control signaling may be another type of control signaling.

At 710, the network entity 105-b may transmit, to the UE 115-b, second control signaling indicating a second configuration associated with monitoring a PDCCH. For example, the second configuration may configure the UE 115-b to monitor for DCI.

At 715, the network entity 105-b may transmit, to the UE 115-b, DCI based on the UE 115-b monitoring for DCI. The DCI may include an SFI that may indicate one or more flexible symbols of the second subset of flexible symbols as uplink or downlink, or a combination thereof. In some examples, the DCI may include a DCI format (e.g., a DCI format 2_0).

The UE 115-b may determine that the SFI indicates the one or more flexible symbols of the second subset of flexible symbols as downlink, flexible, or uplink, and may, at 720, convert the one or more flexible symbols accordingly. For example, the UE 115-b may determine that the one or more flexible symbols of the second subset of flexible symbols are indicated as downlink or flexible based on the SFI. Performing the wireless communication at 725 may be based on this determination. For example, the UE 115-b may receive downlink communications at 725 in the one or more flexible symbols of the second subset of flexible symbols that the UE 115-b has determined are indicated as downlink based on the SFI. In some examples, the UE 115-b may determine whether the DCI includes the SFI, and may perform the wireless communication at 725 based on this determination. In some examples, the UE 115-b may determine that the SFI indicates the one or more flexible symbols of the second subset of flexible symbols as flexible, uplink, downlink, or a combination thereof, and may perform the wireless communication at 725 based on this determination.

In some examples, the UE 115-b may determine that the SFI comprises a slot format value other than a specific value (e.g., 255), and may perform the wireless communication at 725 based on this determination. For example, the UE 115-b may determine that the SFI indicates the one or more flexible symbols of the second subset of flexible symbols as downlink based on the SFI comprising the slot format value other than the specific value, and may perform the wireless communication at 725 based on this determination (e.g., the UE 115-b may receive downlink communications in the one or more flexible symbols of the second subset of flexible symbols that the UE 115-b has determined are indicated as downlink based on the SFI). The UE 115-b may interpret the SFI in one of several ways. In a first interpretation, the UE 115-b may determine that the SFI updates one or more frequency resources associated with the one or more flexible symbols of the second subset of flexible symbols to downlink, and may maintain the uplink subband and the one or more guard bands associated with the one or more flexible symbols. In a second example, the UE 115-b may determine that the SFI updates one or more frequency resources associated with the one or more flexible symbols of the second subset of flexible symbols, including the uplink subband and one or more guard bands, to downlink.

In some examples, the UE 115-b may determine that the SFI indicates one or more flexible symbols of the second subset of flexible symbols as uplink based on the SFI including the slot format value other than the specific value. Performing the wireless communication at 725 may be based on this determination. For example, the UE 115-b may transmit one or more uplink communications in the one or more flexible symbols indicated as uplink by the SFI.

In some examples, the UE 115-b may determine that the SFI indicates one or more flexible symbols of the second subset of flexible symbols as flexible based on the SFI including the slot format value other than the specific value. Performing the wireless communication at 725 may be based on this determination. The UE 115-b may interpret the SFI in one of several ways. In a first interpretation, the UE 115-b may determine that the SFI updates one or more frequency resources associated with the one or more flexible symbols of the second subset of flexible symbols to flexible and may maintain the uplink subband and one or more guard bands associated with the one or more flexible symbols. In a second interpretation, the UE 115-b may determine that the SFI updates frequency resources associated with the one or more flexible symbols of the second subset of flexible symbols to flexible, including the uplink subband and one or more guard bands associated with the one or more flexible symbols.

At 725, the UE 115-b and the network entity 105-b may perform wireless communications based on the first configuration, the second configuration, the DCI, or any combination thereof. For example, the UE 115-b and the network entity 105-b may perform wireless communications based on any of the determinations made by the UE 115-b discussed at 720.

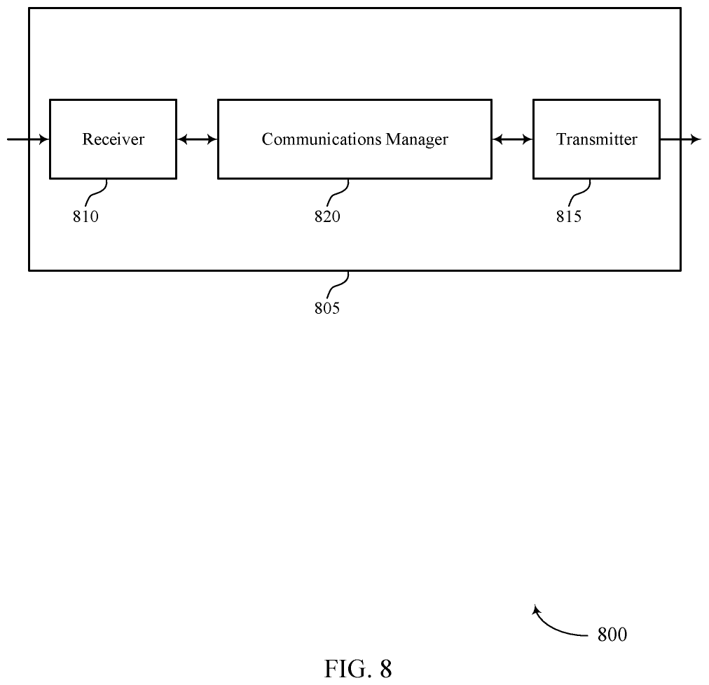

FIG. 8 shows a block diagram 800 of a device 805 that supports wireless communication in SBFD symbols in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to wireless communication in SBFD symbols). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to wireless communication in SBFD symbols). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of wireless communication in SBFD symbols as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The communications manager 820 is capable of, configured to, or operable to support a means for receiving second control signaling indicating a second configuration associated with monitoring a PDCCH. The communications manager 820 is capable of, configured to, or operable to support a means for receiving DCI based on monitoring the PDCCH, where the DCI includes an SFI, and where the SFI indicates one or more flexible symbols of the second subset of flexible symbols as uplink or downlink, or a combination thereof. The communications manager 820 is capable of, configured to, or operable to support a means for performing wireless communication based on the first configuration, the second configuration, or the DCI, or a combination thereof.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption.

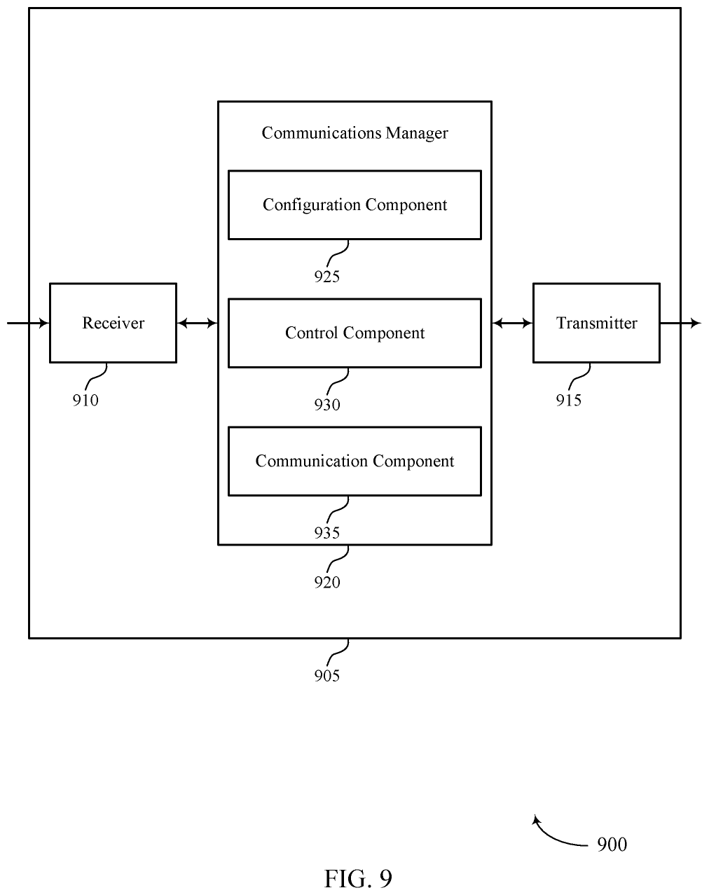

FIG. 9 shows a block diagram 900 of a device 905 that supports wireless communication in SBFD symbols in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to wireless communication in SBFD symbols). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to wireless communication in SBFD symbols). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of wireless communication in SBFD symbols as described herein. For example, the communications manager 920 may include a configuration component 925, a control component 930, a communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The configuration component 925 is capable of, configured to, or operable to support a means for receiving second control signaling indicating a second configuration associated with monitoring a PDCCH. The control component 930 is capable of, configured to, or operable to support a means for receiving DCI based on monitoring the PDCCH, where the DCI includes an SFI, and where the SFI indicates one or more flexible symbols of the second subset of flexible symbols as uplink or downlink, or a combination thereof. The communication component 935 is capable of, configured to, or operable to support a means for performing wireless communication based on the first configuration, the second configuration, or the DCI, or a combination thereof.

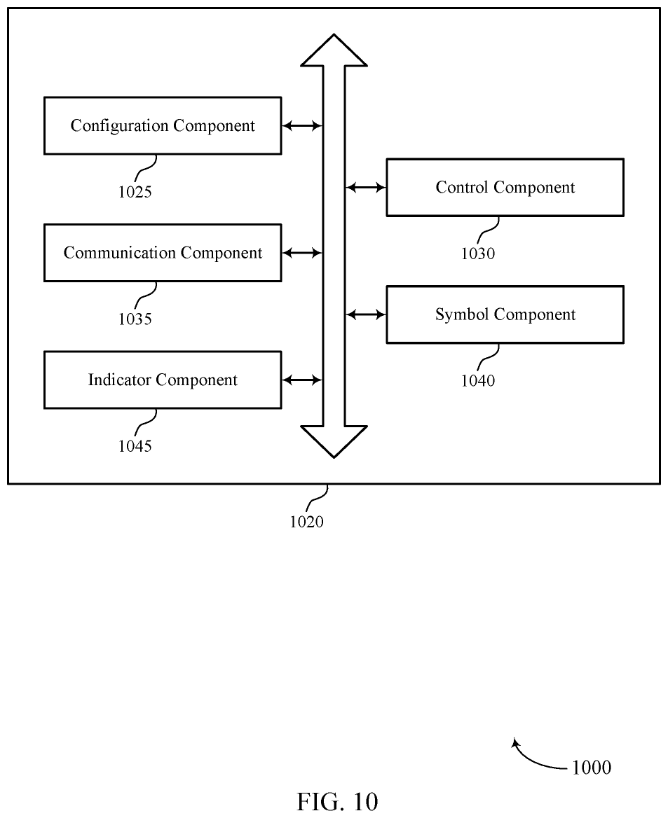

FIG. 10 shows a block diagram 1000 of a communications manager 1020 that supports wireless communication in SBFD symbols in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of wireless communication in SBFD symbols as described herein. For example, the communications manager 1020 may include a configuration component 1025, a control component 1030, a communication component 1035, a symbol component 1040, an indicator component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The configuration component 1025 is capable of, configured to, or operable to support a means for receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. In some examples, the configuration component 1025 is capable of, configured to, or operable to support a means for receiving second control signaling indicating a second configuration associated with monitoring a PDCCH. The control component 1030 is capable of, configured to, or operable to support a means for receiving DCI based on monitoring the PDCCH, where the DCI includes an SFI, and where the SFI indicates one or more flexible symbols of the second subset of flexible symbols as uplink or downlink, or a combination thereof. The communication component 1035 is capable of, configured to, or operable to support a means for performing wireless communication based on the first configuration, the second configuration, or the DCI, or a combination thereof.

In some examples, the symbol component 1040 is capable of, configured to, or operable to support a means for determining that the one or more flexible symbols of the second subset of flexible symbols are indicated as downlink or flexible based on the SFI. In some examples, the communication component 1035 is capable of, configured to, or operable to support a means for performing the wireless communication based on determining that the one or more flexible symbols of the second subset of flexible symbols are indicated as downlink or flexible.

In some examples, the control component 1030 is capable of, configured to, or operable to support a means for determining whether the DCI includes the SFI. In some examples, the communication component 1035 is capable of, configured to, or operable to support a means for performing the wireless communication based on determining whether the DCI includes the SFI.

In some examples, the indicator component 1045 is capable of, configured to, or operable to support a means for determining that the SFI indicates the one or more flexible symbols of the second subset of flexible symbols as flexible, uplink, downlink, or a combination thereof. In some examples, the communication component 1035 is capable of, configured to, or operable to support a means for performing the wireless communication based on determining that the SFI indicates the one or more flexible symbols of the second subset of flexible symbols as flexible, uplink, downlink, or a combination thereof.

In some examples, the indicator component 1045 is capable of, configured to, or operable to support a means for determining that the SFI includes a slot format value below a threshold value. In some examples, the SFI indicates the one or more flexible symbols of the second subset of flexible symbols as uplink or downlink, or a combination thereof, based on the SFI including the slot format value below the threshold value.

In some examples, the indicator component 1045 is capable of, configured to, or operable to support a means for determining that the SFI indicates the one or more flexible symbols of the second subset of flexible symbols as downlink based on the SFI including the slot format value below the threshold value. In some examples, the communication component 1035 is capable of, configured to, or operable to support a means for performing the wireless communication based on determining that the SFI indicates the one or more flexible symbols of the second subset of flexible symbols as downlink.

In some examples, the indicator component 1045 is capable of, configured to, or operable to support a means for determining that the SFI updates one or more frequency resources associated with the one or more flexible symbols of the second subset of flexible symbols to downlink and maintains the uplink subband and one or more guard bands associated with the one or more flexible symbols. In some examples, the communication component 1035 is capable of, configured to, or operable to support a means for performing the wireless communication based on determining that the SFI updates the one or more frequency resources associated with the one or more flexible symbols of the second subset of flexible symbols to downlink and maintains the uplink subband and the one or more guard bands associated with the one or more flexible symbols.

In some examples, the indicator component 1045 is capable of, configured to, or operable to support a means for determining that the SFI updates frequency resources associated with the one or more flexible symbols of the second subset of flexible symbols, including the uplink subband and one or more guard bands, to downlink. In some examples, the communication component 1035 is capable of, configured to, or operable to support a means for performing the wireless communication based on determining that the SFI updates the frequency resources associated with the one or more flexible symbols of the second subset of flexible symbols, including the uplink subband and the one or more guard bands, to downlink.

In some examples, the indicator component 1045 is capable of, configured to, or operable to support a means for determining that the SFI indicates one or more flexible symbols of the second subset of flexible symbols as uplink. In some examples, the communication component 1035 is capable of, configured to, or operable to support a means for performing the wireless communication based on determining that the SFI indicates one or more flexible symbols of the second subset of flexible symbols as uplink.

In some examples, the indicator component 1045 is capable of, configured to, or operable to support a means for determining that the SFI indicates one or more flexible symbols of the second subset of flexible symbols as flexible. In some examples, the communication component 1035 is capable of, configured to, or operable to support a means for performing the wireless communication based on determining that the SFI indicates the one or more flexible symbols of the second subset of flexible symbols as flexible.

In some examples, the indicator component 1045 is capable of, configured to, or operable to support a means for determining that the SFI updates one or more frequency resources associated with the one or more flexible symbols of the second subset of flexible symbols to flexible and maintains the uplink subband and one or more guard bands. In some examples, the communication component 1035 is capable of, configured to, or operable to support a means for performing the wireless communication based on determining that the SFI updates the one or more frequency resources associated with the one or more flexible symbols of the second subset of flexible symbols to flexible and maintains the uplink subband and the one or more guard bands.

In some examples, the indicator component 1045 is capable of, configured to, or operable to support a means for determining that the SFI updates frequency resources associated with the one or more flexible symbols of the second subset of flexible symbols to flexible, including the uplink subband and one or more guard bands. In some examples, the communication component 1035 is capable of, configured to, or operable to support a means for performing the wireless communication based on determining that the SFI updates the frequency resources associated with the one or more flexible symbols of the second subset of flexible symbols to flexible, including the uplink subband and the one or more guard bands.

In some examples, to support, receiving the first control signaling, the configuration component 1025 is capable of, configured to, or operable to support a means for receiving an RRC message indicating the first configuration including the set of symbols associated with the SBFD operation.

In some examples, the DCI includes a DCI format. In some examples, the DCI format includes a DCI format 2_0.

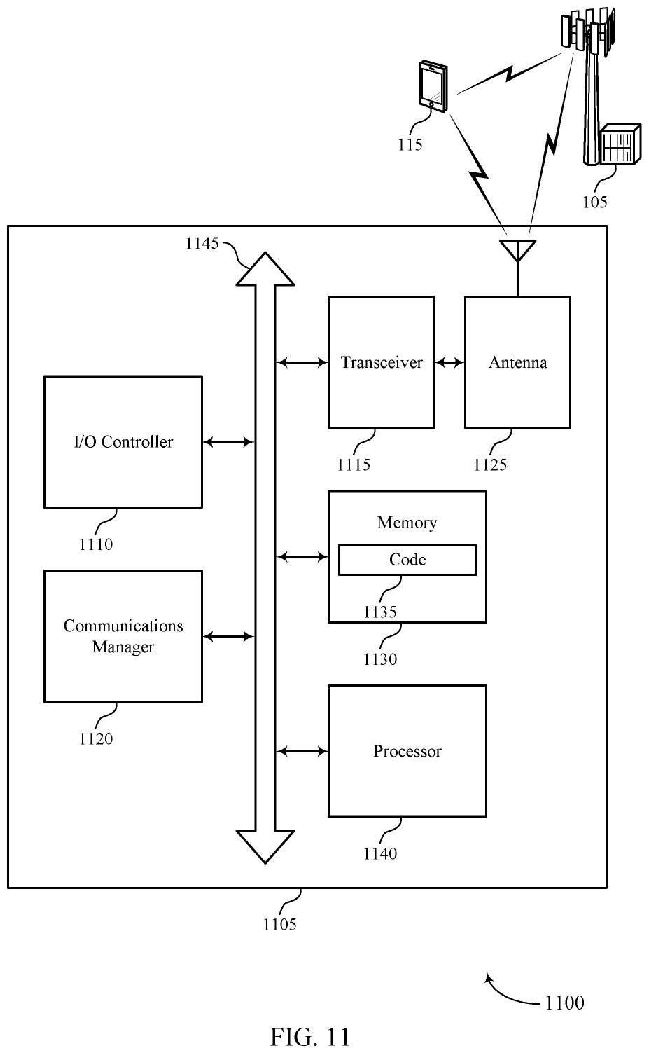

FIG. 11 shows a diagram of a system 1100 including a device 1105 that supports wireless communication in SBFD symbols in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting wireless communication in SBFD symbols). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories.

One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. As such, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The communications manager 1120 is capable of, configured to, or operable to support a means for receiving second control signaling indicating a second configuration associated with monitoring a PDCCH. The communications manager 1120 is capable of, configured to, or operable to support a means for receiving DCI based on monitoring the PDCCH, where the DCI includes an SFI, and where the SFI indicates one or more flexible symbols of the second subset of flexible symbols as uplink or downlink, or a combination thereof. The communications manager 1120 is capable of, configured to, or operable to support a means for performing wireless communication based on the first configuration, the second configuration, or the DCI, or a combination thereof.

By including or configuring the communications manager 1120 in accordance with examples as described herein, the device 1105 may support techniques for longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of wireless communication in SBFD symbols as described herein, or the at least one processor 1140 and the at least one memory 1130 may be otherwise configured to, individually or collectively, perform or support such operations.

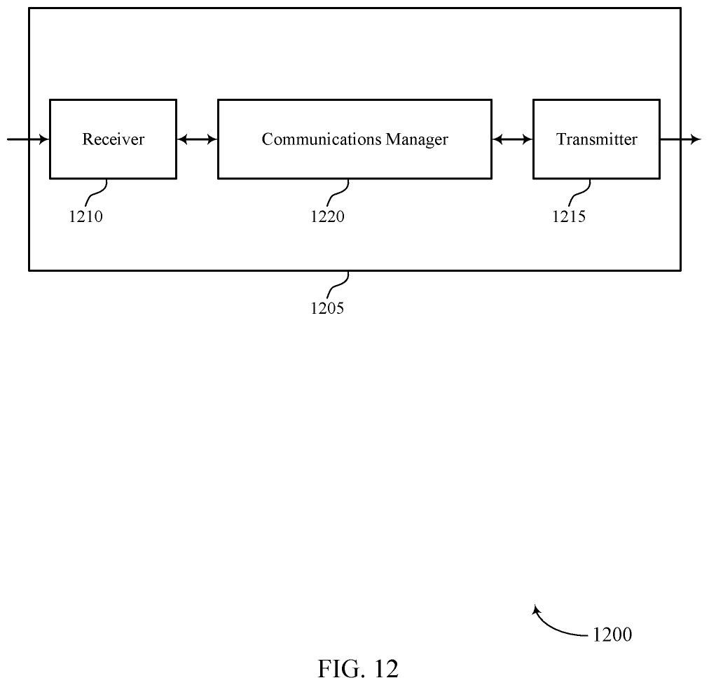

FIG. 12 shows a block diagram 1200 of a device 1205 that supports wireless communication in SBFD symbols in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of wireless communication in SBFD symbols as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The communications manager 1220 is capable of, configured to, or operable to support a means for transmitting second control signaling indicating a second configuration associated with monitoring a PDCCH. The communications manager 1220 is capable of, configured to, or operable to support a means for transmitting DCI, where the DCI includes an SFI, and where the SFI indicates one or more flexible symbols of the second subset of flexible symbols as uplink or downlink, or a combination thereof. The communications manager 1220 is capable of, configured to, or operable to support a means for performing wireless communication based on the first configuration, the second configuration, or the DCI, or a combination thereof.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

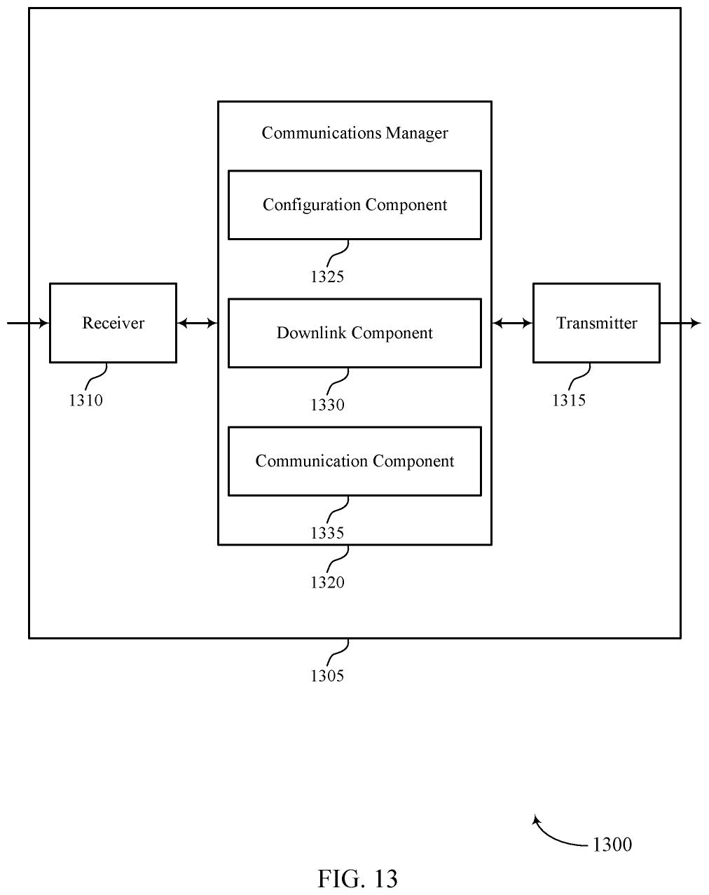

FIG. 13 shows a block diagram 1300 of a device 1305 that supports wireless communication in SBFD symbols in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of wireless communication in SBFD symbols as described herein. For example, the communications manager 1320 may include a configuration component 1325, a downlink component 1330, a communication component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The configuration component 1325 is capable of, configured to, or operable to support a means for transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The configuration component 1325 is capable of, configured to, or operable to support a means for transmitting second control signaling indicating a second configuration associated with monitoring a PDCCH. The downlink component 1330 is capable of, configured to, or operable to support a means for transmitting DCI, where the DCI includes an SFI, and where the SFI indicates one or more flexible symbols of the second subset of flexible symbols as uplink or downlink, or a combination thereof. The communication component 1335 is capable of, configured to, or operable to support a means for performing wireless communication based on the first configuration, the second configuration, or the DCI, or a combination thereof.

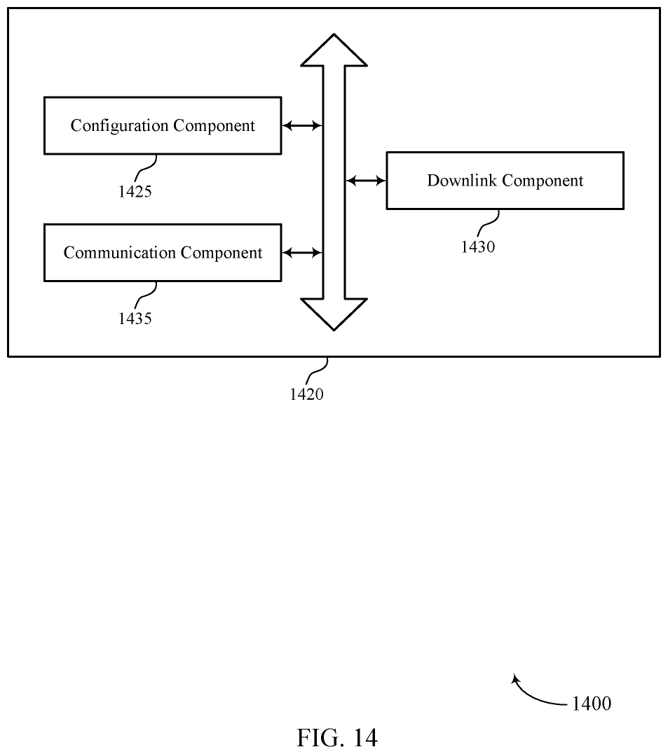

FIG. 14 shows a block diagram 1400 of a communications manager 1420 that supports wireless communication in SBFD symbols in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of wireless communication in SBFD symbols as described herein. For example, the communications manager 1420 may include a configuration component 1425, a downlink component 1430, a communication component 1435, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The configuration component 1425 is capable of, configured to, or operable to support a means for transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. In some examples, the configuration component 1425 is capable of, configured to, or operable to support a means for transmitting second control signaling indicating a second configuration associated with monitoring a PDCCH. The downlink component 1430 is capable of, configured to, or operable to support a means for transmitting DCI, where the DCI includes an SFI, and where the SFI indicates one or more flexible symbols of the second subset of flexible symbols as uplink or downlink, or a combination thereof. The communication component 1435 is capable of, configured to, or operable to support a means for performing wireless communication based on the first configuration, the second configuration, or the DCI, or a combination thereof.

In some examples, the one or more flexible symbols of the second subset of flexible symbols are indicated as downlink or flexible based on the SFI. In some examples, the DCI includes the SFI. In some examples, the SFI indicates the one or more flexible symbols of the second subset of flexible symbols as flexible, uplink, downlink, or a combination thereof.

In some examples, the SFI includes a slot format value below a threshold value. In some examples, the SFI indicates the one or more flexible symbols of the second subset of flexible symbols as downlink based on the SFI including the slot format value below the threshold value.

In some examples, the SFI updates one or more frequency resources associated with the one or more flexible symbols of the second subset of flexible symbols to downlink and maintains the uplink subband and one or more guard bands associated with the one or more flexible symbols.

In some examples, the SFI updates frequency resources associated with the one or more flexible symbols of the second subset of flexible symbols, including the uplink subband and one or more guard bands, to downlink.

In some examples, the SFI indicates one or more flexible symbols of the second subset of flexible symbols as uplink. In some examples, the SFI indicates one or more flexible symbols of the second subset of flexible symbols as flexible.

In some examples, the SFI updates one or more frequency resources associated with the one or more flexible symbols of the second subset of flexible symbols to flexible and maintains the uplink subband and one or more guard bands. In some examples, the SFI updates frequency resources associated with the one or more flexible symbols of the second subset of flexible symbols to flexible, including the uplink subband and one or more guard bands.

In some examples, to support, transmitting the first control signaling, the configuration component 1425 is capable of, configured to, or operable to support a means for transmitting an RRC message indicating the first configuration including the set of symbols associated with the SBFD operation.

In some examples, the DCI includes a DCI format. In some examples, the DCI format includes a DCI format 2_0.

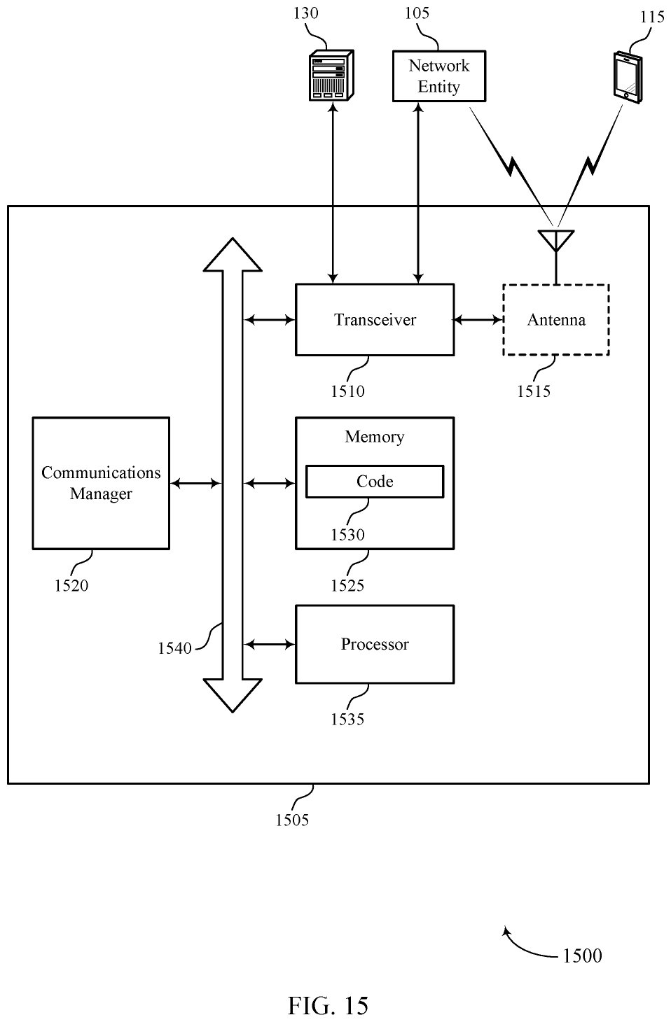

FIG. 15 shows a diagram of a system 1500 including a device 1505 that supports wireless communication in SBFD symbols in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals.

In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting wireless communication in SBFD symbols). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505.

The at least one processor 1535 may be any one or more suitable processors capable of executing scripts or instructions of one or more software programs stored in the device 1505 (such as within one or more of the at least one memory 1525). In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. As such, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The communications manager 1520 is capable of, configured to, or operable to support a means for transmitting second control signaling indicating a second configuration associated with monitoring a PDCCH. The communications manager 1520 is capable of, configured to, or operable to support a means for transmitting DCI, where the DCI includes an SFI, and where the SFI indicates one or more flexible symbols of the second subset of flexible symbols as uplink or downlink, or a combination thereof. The communications manager 1520 is capable of, configured to, or operable to support a means for performing wireless communication based on the first configuration, the second configuration, or the DCI, or a combination thereof.

By including or configuring the communications manager 1520 in accordance with examples as described herein, the device 1505 may support techniques for more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of wireless communication in SBFD symbols as described herein, or the at least one processor 1535 and the at least one memory 1525 may be otherwise configured to, individually or collectively, perform or support such operations.

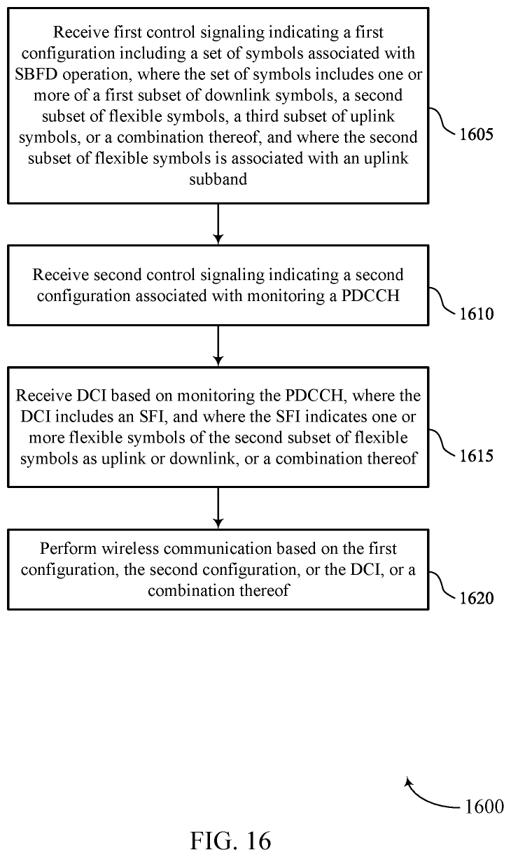

FIG. 16 shows a flowchart illustrating a method 1600 that supports wireless communication in SBFD symbols in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The operations of block 1605 may be performed in accordance with examples as disclosed herein, such as the reception of the first control signaling 205 of FIG. 2 and at step 705 of FIG. 7. In some examples, aspects of the operations of 1605 may be performed by a configuration component 1025 as described with reference to FIG. 10.

At 1610, the method may include receiving second control signaling indicating a second configuration associated with monitoring a PDCCH. The operations of block 1610 may be performed in accordance with examples as disclosed herein, such as the reception of the second control signaling 210 of FIG. 2 and at 710 of FIG. 7. In some examples, aspects of the operations of 1610 may be performed by a configuration component 1025 as described with reference to FIG. 10.

At 1615, the method may include receiving DCI based on monitoring the PDCCH, where the DCI includes an SFI, and where the SFI indicates one or more flexible symbols of the second subset of flexible symbols as uplink or downlink, or a combination thereof. The operations of block 1615 may be performed in accordance with examples as disclosed herein, such as the reception of the DCI 215 of FIG. 2 and at 715 of FIG. 7. In some examples, aspects of the operations of 1615 may be performed by a control component 1030 as described with reference to FIG. 10.

At 1620, the method may include performing wireless communication based on the first configuration, the second configuration, or the DCI, or a combination thereof. The operations of block 1620 may be performed in accordance with examples as disclosed herein, such as the wireless communications 220 of FIG. 2 and at 725 of FIG. 7. In some examples, aspects of the operations of 1620 may be performed by a communication component 1035 as described with reference to FIG. 10.

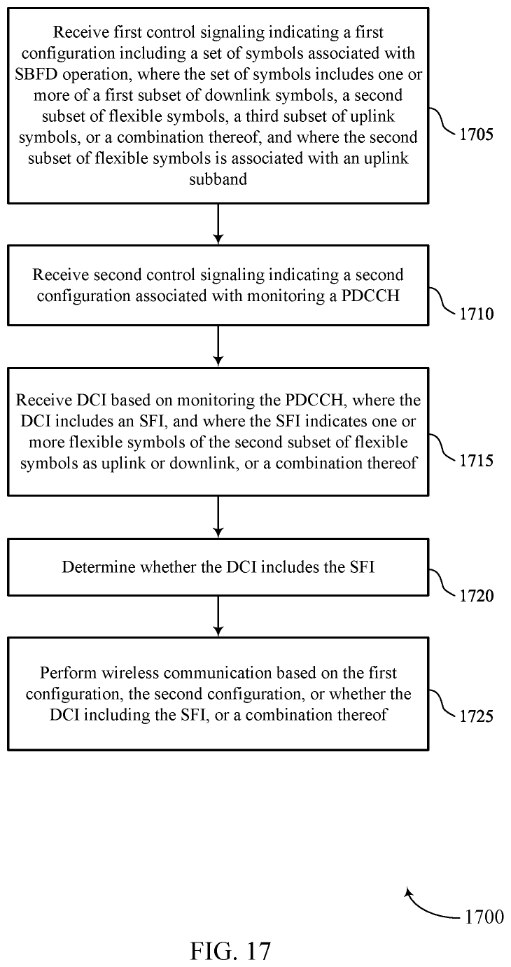

FIG. 17 shows a flowchart illustrating a method 1700 that supports wireless communication in SBFD symbols in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The operations of block 1705 may be performed in accordance with examples as disclosed herein, such as the reception of the first control signaling 205 of FIG. 2 and at 705 of FIG. 7. In some examples, aspects of the operations of 1705 may be performed by a configuration component 1025 as described with reference to FIG. 10.

At 1710, the method may include receiving second control signaling indicating a second configuration associated with monitoring a PDCCH. The operations of block 1710 may be performed in accordance with examples as disclosed herein, such as the reception of the second control signaling 210 of FIG. 2 and at 710 of FIG. 7. In some examples, aspects of the operations of 1710 may be performed by a configuration component 1025 as described with reference to FIG. 10.

At 1715, the method may include receiving DCI based on monitoring the PDCCH, where the DCI includes an SFI, and where the SFI indicates one or more flexible symbols of the second subset of flexible symbols as uplink or downlink, or a combination thereof. The operations of block 1715 may be performed in accordance with examples as disclosed herein, such as the reception of the DCI 215 of FIG. 2 and at 715 of FIG. 7. In some examples, aspects of the operations of 1715 may be performed by a control component 1030 as described with reference to FIG. 10.

At 1720, the method may include determining whether the DCI includes the SFI. The operations of block 1720 may be performed in accordance with examples as disclosed herein, such as at 720 of FIG. 7. In some examples, aspects of the operations of 1720 may be performed by a control component 1030 as described with reference to FIG. 10.

At 1725, the method may include performing wireless communication based on the first configuration, the second configuration, or whether the DCI including the SFI, or a combination thereof. The operations of block 1725 may be performed in accordance with examples as disclosed herein, such as the wireless communications 220 of FIG. 2 and at 725 of FIG. 7. In some examples, aspects of the operations of 1725 may be performed by a communication component 1035 as described with reference to FIG. 10.

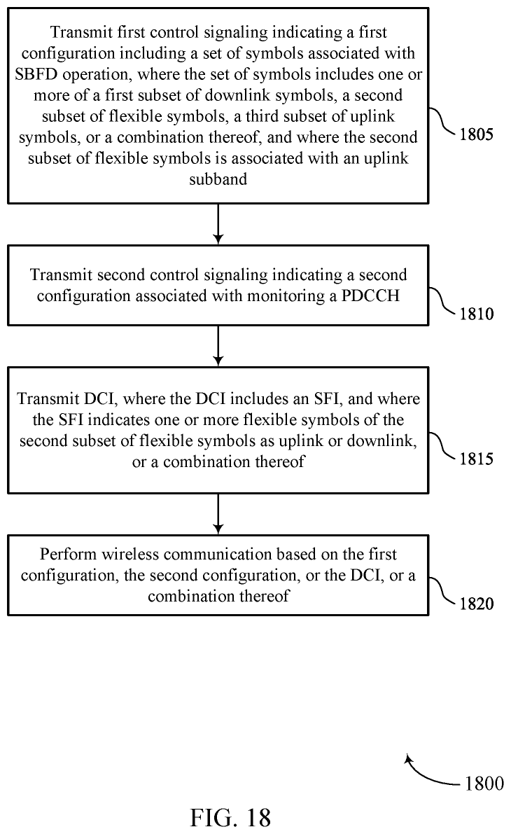

FIG. 18 shows a flowchart illustrating a method 1800 that supports wireless communication in SBFD symbols in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting first control signaling indicating a first configuration including a set of symbols associated with SBFD operation, where the set of symbols includes one or more of a first subset of downlink symbols, a second subset of flexible symbols, a third subset of uplink symbols, or a combination thereof, and where the second subset of flexible symbols is associated with an uplink subband. The operations of block 1805 may be performed in accordance with examples as disclosed herein, such as the transmission of the first control signaling 205 of FIG. 2 and at 705 of FIG. 7. In some examples, aspects of the operations of 1805 may be performed by a configuration component 1425 as described with reference to FIG. 14.

At 1810, the method may include transmitting second control signaling indicating a second configuration associated with monitoring a PDCCH. The operations of block 1810 may be performed in accordance with examples as disclosed herein, such as the transmission of the second control signaling 210 of FIG. 2 and at 710 of FIG. 7. In some examples, aspects of the operations of 1810 may be performed by a configuration component 1425 as described with reference to FIG. 14.

At 1815, the method may include transmitting DCI, where the DCI includes an SFI, and where the SFI indicates one or more flexible symbols of the second subset of flexible symbols as uplink or downlink, or a combination thereof. The operations of block 1815 may be performed in accordance with examples as disclosed herein, such as the transmission of the DCI 215 of FIG. 2 and at 715 of FIG. 7. In some examples, aspects of the operations of 1815 may be performed by a downlink component 1430 as described with reference to FIG. 14.

At 1820, the method may include performing wireless communication based on the first configuration, the second configuration, or the DCI, or a combination thereof. The operations of block 1820 may be performed in accordance with examples as disclosed herein, such as the wireless communications 220 of FIG. 2 and at 725 of FIG. 7. In some examples, aspects of the operations of 1820 may be performed by a communication component 1435 as described with reference to FIG. 14.

The following provides an overview of aspects of the present disclosure:

Aspect 1: A method for wireless communications at a UE, comprising: receiving first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband; receiving second control signaling indicating a second configuration associated with monitoring a physical downlink control channel; receiving downlink control information based at least in part on monitoring the physical downlink control channel, wherein the downlink control information comprises a slot format indicator, and wherein the slot format indicator indicates one or more flexible symbols of the second subset of flexible symbols as uplink or downlink, or a combination thereof; and performing wireless communication based at least in part on the first configuration, the second configuration, or the downlink control information, or a combination thereof.

Aspect 2: The method of aspect 1, further comprising: determining that the one or more flexible symbols of the second subset of flexible symbols are indicated as downlink or flexible based at least in part on the slot format indicator, wherein performing the wireless communication is based at least in part on determining that the one or more flexible symbols of the second subset of flexible symbols are indicated as downlink or flexible.

Aspect 3: The method of any of aspects 1 through 2, further comprising: determining whether the downlink control information includes the slot format indicator, wherein performing the wireless communication is based at least in part on determining whether the downlink control information includes the slot format indicator.

Aspect 4: The method of any of aspects 1 through 3, further comprising: determining that the slot format indicator indicates the one or more flexible symbols of the second subset of flexible symbols as flexible, uplink, downlink, or a combination thereof, wherein performing the wireless communication is based at least in part on determining that the slot format indicator indicates the one or more flexible symbols of the second subset of flexible symbols as flexible, uplink, downlink, or a combination thereof.

Aspect 5: The method of any of aspects 1 through 4, further comprising: determining that the slot format indicator comprises a slot format value below a threshold value, wherein the slot format indicator indicates the one or more flexible symbols of the second subset of flexible symbols as uplink or downlink, or a combination thereof, based at least in part on the slot format indicator comprising the slot format value below the threshold value.

Aspect 6: The method of aspect 5, further comprising: determining that the slot format indicator indicates the one or more flexible symbols of the second subset of flexible symbols as downlink based at least in part on the slot format indicator comprising the slot format value below the threshold value, wherein performing the wireless communication is based at least in part on determining that the slot format indicator indicates the one or more flexible symbols of the second subset of flexible symbols as downlink.

Aspect 7: The method of aspect 6, further comprising: determining that the slot format indicator updates one or more frequency resources associated with the one or more flexible symbols of the second subset of flexible symbols to downlink and maintains the uplink subband and one or more guard bands associated with the one or more flexible symbols, wherein performing the wireless communication is based at least in part on determining that the slot format indicator updates the one or more frequency resources associated with the one or more flexible symbols of the second subset of flexible symbols to downlink and maintains the uplink subband and the one or more guard bands associated with the one or more flexible symbols.

Aspect 8: The method of aspect 6, further comprising: determining that the slot format indicator updates frequency resources associated with the one or more flexible symbols of the second subset of flexible symbols, including the uplink subband and one or more guard bands, to downlink, wherein performing the wireless communication is based at least in part on determining that the slot format indicator updates the frequency resources associated with the one or more flexible symbols of the second subset of flexible symbols, including the uplink subband and the one or more guard bands, to downlink.

Aspect 9: The method of aspect 5, further comprising: determining that the slot format indicator indicates one or more flexible symbols of the second subset of flexible symbols as uplink, wherein performing the wireless communication is based at least in part on determining that the slot format indicator indicates one or more flexible symbols of the second subset of flexible symbols as uplink.

Aspect 10: The method of any of aspects 5 and 9, further comprising: determining that the slot format indicator indicates one or more flexible symbols of the second subset of flexible symbols as flexible, wherein performing the wireless communication is based at least in part on determining that the slot format indicator indicates the one or more flexible symbols of the second subset of flexible symbols as flexible.

Aspect 11: The method of aspect 10, further comprising: determining that the slot format indicator updates one or more frequency resources associated with the one or more flexible symbols of the second subset of flexible symbols to flexible and maintains the uplink subband and one or more guard bands, wherein performing the wireless communication is based at least in part on determining that the slot format indicator updates the one or more frequency resources associated with the one or more flexible symbols of the second subset of flexible symbols to flexible and maintains the uplink subband and the one or more guard bands.

Aspect 12: The method of aspect 10, further comprising: determining that the slot format indicator updates frequency resources associated with the one or more flexible symbols of the second subset of flexible symbols to flexible, including the uplink subband and one or more guard bands, wherein performing the wireless communication is based at least in part on determining that the slot format indicator updates the frequency resources associated with the one or more flexible symbols of the second subset of flexible symbols to flexible, including the uplink subband and the one or more guard bands.

Aspect 13: The method of any of aspects 1 through 12, wherein, receiving the first control signaling, comprises: receiving an RRC message indicating the first configuration comprising the set of symbols associated with the subband full duplex operation.

Aspect 14: The method of any of aspects 1 through 13, wherein the downlink control information comprises a downlink control information format, and the downlink control information format comprises a downlink control information format 2_0.

Aspect 15: A method for wireless communications at a network entity, comprising: transmitting first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband; transmitting second control signaling indicating a second configuration associated with monitoring a physical downlink control channel; transmitting downlink control information, wherein the downlink control information comprises a slot format indicator, and wherein the slot format indicator indicates one or more flexible symbols of the second subset of flexible symbols as uplink or downlink, or a combination thereof; and performing wireless communication based at least in part on the first configuration, the second configuration, or the downlink control information, or a combination thereof.

Aspect 16: The method of aspect 15, wherein the one or more flexible symbols of the second subset of flexible symbols are indicated as downlink or flexible based at least in part on the slot format indicator.

Aspect 17: The method of any of aspects 15 through 16, wherein the downlink control information includes the slot format indicator.

Aspect 18: The method of any of aspects 15 through 17, wherein the slot format indicator indicates the one or more flexible symbols of the second subset of flexible symbols as flexible, uplink, downlink, or a combination thereof.

Aspect 19: The method of any of aspects 15 through 18, wherein the slot format indicator comprises a slot format value below a threshold value.

Aspect 20: The method of aspect 19, wherein the slot format indicator indicates the one or more flexible symbols of the second subset of flexible symbols as downlink based at least in part on the slot format indicator comprising the slot format value below the threshold value.

Aspect 21: The method of aspect 20, wherein the slot format indicator updates one or more frequency resources associated with the one or more flexible symbols of the second subset of flexible symbols to downlink and maintains the uplink subband and one or more guard bands associated with the one or more flexible symbols.

Aspect 22: The method of aspect 20, wherein the slot format indicator updates frequency resources associated with the one or more flexible symbols of the second subset of flexible symbols, including the uplink subband and one or more guard bands, to downlink.

Aspect 23: The method of aspect 19, wherein the slot format indicator indicates one or more flexible symbols of the second subset of flexible symbols as uplink.

Aspect 24: The method of aspect 19, wherein the slot format indicator indicates one or more flexible symbols of the second subset of flexible symbols as flexible.

Aspect 25: The method of aspect 24, wherein the slot format indicator updates one or more frequency resources associated with the one or more flexible symbols of the second subset of flexible symbols to flexible and maintains the uplink subband and one or more guard bands.

Aspect 26: The method of aspect 24, wherein the slot format indicator updates frequency resources associated with the one or more flexible symbols of the second subset of flexible symbols to flexible, including the uplink subband and one or more guard bands.

Aspect 27: The method of any of aspects 15 through 26, wherein, transmitting the first control signaling, comprises: transmitting an RRC message indicating the first configuration comprising the set of symbols associated with the subband full duplex operation.

Aspect 28: A UE for wireless communications, comprising one or more memories storing processor-executable code, and one or more processors coupled with the one or more memories and individually or collectively operable to execute the code to cause the UE to perform a method of any of aspects 1 through 14.

Aspect 29: A UE for wireless communications, comprising at least one means for performing a method of any of aspects 1 through 14.

Aspect 30: A non-transitory computer-readable medium storing code for wireless communications, the code comprising instructions executable by a processor to perform a method of any of aspects 1 through 14.

Aspect 31: A network entity for wireless communications, comprising one or more memories storing processor-executable code, and one or more processors coupled with the one or more memories and individually or collectively operable to execute the code to cause the network entity to perform a method of any of aspects 15 through 27.

Aspect 32: A network entity for wireless communications, comprising at least one means for performing a method of any of aspects 15 through 27.

Aspect 33: A non-transitory computer-readable medium storing code for wireless communications, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband;
receive second control signaling indicating a second configuration associated with monitoring a physical downlink control channel;
receive downlink control information based at least in part on monitoring the physical downlink control channel, wherein the downlink control information comprises a slot format indicator, and wherein the slot format indicator indicates one or more flexible symbols of the second subset of flexible symbols as uplink or downlink, or a combination thereof; and
perform wireless communication based at least in part on the first configuration, the second configuration, or the downlink control information, or a combination thereof.

2. The UE of claim 1, wherein the one or more processors are individually or collectively further operable to execute the code to cause the UE to:
determine that the one or more flexible symbols of the second subset of flexible symbols are indicated as downlink or flexible based at least in part on the slot format indicator,
wherein to perform the wireless communication is based at least in part on determining that the one or more flexible symbols of the second subset of flexible symbols are indicated as downlink or flexible.

3. The UE of claim 1, wherein the one or more processors are individually or collectively further operable to execute the code to cause the UE to:
determine whether the downlink control information includes the slot format indicator,
wherein to perform the wireless communication is based at least in part on determining whether the downlink control information includes the slot format indicator.

4. The UE of claim 1, wherein the one or more processors are individually or collectively further operable to execute the code to cause the UE to:
determine that the slot format indicator indicates the one or more flexible symbols of the second subset of flexible symbols as flexible, uplink, downlink, or a combination thereof,
wherein to perform the wireless communication is based at least in part on determining that the slot format indicator indicates the one or more flexible symbols of the second subset of flexible symbols as flexible, uplink, downlink, or a combination thereof.

5. The UE of claim 1, wherein the one or more processors are individually or collectively further operable to execute the code to cause the UE to:
determine that the slot format indicator comprises a slot format value below a threshold value,
wherein the slot format indicator indicates the one or more flexible symbols of the second subset of flexible symbols as uplink or downlink, or a combination thereof, based at least in part on the slot format indicator comprising the slot format value below the threshold value.

6. The UE of claim 5, wherein the one or more processors are individually or collectively further operable to execute the code to cause the UE to:
determine that the slot format indicator indicates the one or more flexible symbols of the second subset of flexible symbols as downlink based at least in part on the slot format indicator comprising the slot format value below the threshold value,
wherein to perform the wireless communication is based at least in part on determining that the slot format indicator indicates the one or more flexible symbols of the second subset of flexible symbols as downlink.

7. The UE of claim 6, wherein the one or more processors are individually or collectively further operable to execute the code to cause the UE to:
determine that the slot format indicator updates one or more frequency resources associated with the one or more flexible symbols of the second subset of flexible symbols to downlink and maintains the uplink subband and one or more guard bands associated with the one or more flexible symbols,
wherein to perform the wireless communication is based at least in part on determining that the slot format indicator updates the one or more frequency resources associated with the one or more flexible symbols of the second subset of flexible symbols to downlink and maintains the uplink subband and the one or more guard bands associated with the one or more flexible symbols.

8. The UE of claim 6, wherein the one or more processors are individually or collectively further operable to execute the code to cause the UE to:
determine that the slot format indicator updates frequency resources associated with the one or more flexible symbols of the second subset of flexible symbols, including the uplink subband and one or more guard bands, to downlink,
wherein to perform the wireless communication is based at least in part on determining that the slot format indicator updates the frequency resources associated with the one or more flexible symbols of the second subset of flexible symbols, including the uplink subband and the one or more guard bands, to downlink.

9. The UE of claim 5, wherein the one or more processors are individually or collectively further operable to execute the code to cause the UE to:
determine that the slot format indicator indicates one or more flexible symbols of the second subset of flexible symbols as uplink,
wherein to perform the wireless communication is based at least in part on determining that the slot format indicator indicates one or more flexible symbols of the second subset of flexible symbols as uplink.

10. The UE of claim 5, wherein the one or more processors are individually or collectively further operable to execute the code to cause the UE to:
determine that the slot format indicator indicates one or more flexible symbols of the second subset of flexible symbols as flexible,
wherein to perform the wireless communication is based at least in part on determining that the slot format indicator indicates the one or more flexible symbols of the second subset of flexible symbols as flexible.

11. The UE of claim 10, wherein the one or more processors are individually or collectively further operable to execute the code to cause the UE to:
determine that the slot format indicator updates one or more frequency resources associated with the one or more flexible symbols of the second subset of flexible symbols to flexible and maintains the uplink subband and one or more guard bands,
wherein to perform the wireless communication is based at least in part on determining that the slot format indicator updates the one or more frequency resources associated with the one or more flexible symbols of the second subset of flexible symbols to flexible and maintains the uplink subband and the one or more guard bands.

12. The UE of claim 10, wherein the one or more processors are individually or collectively further operable to execute the code to cause the UE to:
determine that the slot format indicator updates frequency resources associated with the one or more flexible symbols of the second subset of flexible symbols to flexible, including the uplink subband and one or more guard bands,
wherein to perform the wireless communication is based at least in part on determining that the slot format indicator updates the frequency resources associated with the one or more flexible symbols of the second subset of flexible symbols to flexible, including the uplink subband and the one or more guard bands.

13. The UE of claim 1, wherein, to receive the first control signaling, the one or more processors are individually or collectively operable to execute the code to cause the UE to:
receive a radio resource control message indicating the first configuration comprising the set of symbols associated with the subband full duplex operation.

14. The UE of claim 1, wherein the downlink control information comprises a downlink control information format, and the downlink control information format comprises a downlink control information format 2_0.

15. A network entity, comprising:
one or more memories storing processor-executable code; and
one or more processors coupled with the one or more memories and individually or collectively operable to execute the code to cause the network entity to:
transmit first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband;
transmit second control signaling indicating a second configuration associated with monitoring a physical downlink control channel;
transmit downlink control information, wherein the downlink control information comprises a slot format indicator, and wherein the slot format indicator indicates one or more flexible symbols of the second subset of flexible symbols as uplink or downlink, or a combination thereof; and
perform wireless communication based at least in part on the first configuration, the second configuration, or the downlink control information, or a combination thereof.

16. The network entity of claim 15, wherein the one or more flexible symbols of the second subset of flexible symbols are indicated as downlink or flexible based at least in part on the slot format indicator.

17. The network entity of claim 15, wherein the downlink control information includes the slot format indicator.

18. The network entity of claim 15, wherein the slot format indicator indicates the one or more flexible symbols of the second subset of flexible symbols as flexible, uplink, downlink, or a combination thereof.

19. The network entity of claim 15, wherein the slot format indicator comprises a slot format value below a threshold value.

20. The network entity of claim 19, wherein the slot format indicator indicates the one or more flexible symbols of the second subset of flexible symbols as downlink based at least in part on the slot format indicator comprising the slot format value below the threshold value.

21. The network entity of claim 20, wherein the slot format indicator updates one or more frequency resources associated with the one or more flexible symbols of the second subset of flexible symbols to downlink and maintains the uplink subband and one or more guard bands associated with the one or more flexible symbols.

22. The network entity of claim 20, wherein the slot format indicator updates frequency resources associated with the one or more flexible symbols of the second subset of flexible symbols, including the uplink subband and one or more guard bands, to downlink.

23. The network entity of claim 19, wherein the slot format indicator indicates one or more flexible symbols of the second subset of flexible symbols as uplink.

24. The network entity of claim 19, wherein the slot format indicator indicates one or more flexible symbols of the second subset of flexible symbols as flexible.

25. The network entity of claim 24, wherein the slot format indicator updates one or more frequency resources associated with the one or more flexible symbols of the second subset of flexible symbols to flexible and maintains the uplink subband and one or more guard bands.

26. The network entity of claim 24, wherein the slot format indicator updates frequency resources associated with the one or more flexible symbols of the second subset of flexible symbols to flexible, including the uplink subband and one or more guard bands.

27. The network entity of claim 15, wherein, to transmit the first control signaling, the one or more processors are individually or collectively operable to execute the code to cause the network entity to:
transmit a radio resource control message indicating the first configuration comprising the set of symbols associated with the subband full duplex operation.

28. The network entity of claim 15, wherein the downlink control information comprises a downlink control information format, and the downlink control information format comprises a downlink control information format 2_0.

29. A method for wireless communications at a user equipment (UE), comprising:
receiving first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband;
receiving second control signaling indicating a second configuration associated with monitoring a physical downlink control channel;
receiving downlink control information based at least in part on monitoring the physical downlink control channel, wherein the downlink control information comprises a slot format indicator, and wherein the slot format indicator indicates one or more flexible symbols of the second subset of flexible symbols as uplink or downlink, or a combination thereof; and
performing wireless communication based at least in part on the first configuration, the second configuration, or the downlink control information, or a combination thereof.

30. A method for wireless communications at a network entity, comprising:
transmitting first control signaling indicating a first configuration comprising a set of symbols associated with subband full duplex operation, wherein the set of symbols comprises one or more of a first subset of downlink symbols, a second subset of flexible symbols, a third subset of uplink symbols, or a combination thereof, and wherein the second subset of flexible symbols is associated with an uplink subband;
transmitting second control signaling indicating a second configuration associated with monitoring a physical downlink control channel;
transmitting downlink control information, wherein the downlink control information comprises a slot format indicator, and wherein the slot format indicator indicates one or more flexible symbols of the second subset of flexible symbols as uplink or downlink, or a combination thereof; and
performing wireless communication based at least in part on the first configuration, the second configuration, or the downlink control information, or a combination thereof.
